(19) United States
(12) Patent Application Publication
(10) Pub. No.: US 2003/0136673 A1
(43) Pub. Date: Jul. 24, 2003

(54) Amperometric sensors using synthetic substrates based on modeled active-site chemistry

(76) Inventors: Denis Pilloud, La Croix-de-Rozon (CH); Kevin McGowan, N. Potomac, MD (US); Guy Farruggia, Ellicott City, MD (US); William Morris, Waldorf, MD (US); Allan B. Fraser, Clarksville, MD (US)

Correspondence Address: ASHEN & LIPPMAN, 4385 OCEAN VIEW BOULEVARD, MONTROSE, CA, 91020, US

(21) Appl. No.: 10/155,745

(22) Filed: May 24, 2002

Related U.S. Application Data
(60) Provisional application No. 60/295,461, filed on May 31, 2001.

(51) Int. Cl. G01N 27/26

(52) U.S. Cl. 204/403.1; 204/403.13; 204/403.14

(57) ABSTRACT

A biosensor for detecting and measuring analytes in an aqueous solution. The biosensor device has a sensor design based on modeling of the active-site chemistry of reactive molecules such as enzymes, antibodies and cellular receptors. The sensor design takes advantage of a synthetic polymer modeled after these reactive molecules to provide reversible, sensitive and reliable detection of analytes in the form of a versatile and economical device.

This document claims priority of U.S. provisional patent application serial No. 60/283,009 filed on May 25, 2001 and serial No. 60/295,461 filed on May 31, 2001; which are both hereby wholly incorporated by reference. Other documents wholly incorporated by reference herein include Guy J. Farrugia and Allan B. Fraser, “Miniature Towed Oceanographic Conductivity Apparatus”, Proceedings of Oceans, Sep. 10-12, 1984.

### BACKGROUND

1. Field of the Invention

This invention relates generally tobiosensors; and more particularly to biosensors which incorporate a sensor design modeled after active-site chemistry, a biosensor device containing a synthetic substrate based on the modeled active-site chemistry, a method of measuring analytes using the device, and a method for making the device.

2. Related Art

Nitrate ion from fertilizers and treated sewage has reached disquietingly high concentrations in water supplies all around the world. In the United States, the Environmental Protection Agency (EPA) has fixed an allowable upper limit of 10 ppm for NO₃⁻ nitrogen (NO₃—N) in drinking water. This is to prevent illnesses caused by higher nitrate levels such as methemoglobinemia (“blue baby syndrome”) in bottle-fed infants. The health and environmental risks associated with elevated nitrate levels are the following:

Methemoglobinemia. Elevated nitrate levels poses a risk to infants and can lead to methemoglobinemia, or “blue baby syndrome”. Elevated levels of nitrate lead to a build-up of nitrite in the gastrointestinal tract by nitrate reducing bacteria. The excess nitrite moves into the bloodstream where it binds strongly to blood hemoglobin and impairs the delivery of oxygen to the baby.

A recent study from the University of Iowa has shown a link between nitrate levels in drinking water and bladder cancer in women (Weyer, et al., 2001)

Blood and serum nitrate levels can become elevated as the result of increased production of nitric oxide (NO). Nitric oxide is an unstable gaseous compound that readily diffuses into body fluids where it can be converted to nitrate, nitrite or S-nitrothiol. NO levels rise during heightened immune-response such as occurs during sepsis, organ failure or graft-rejection.

There is also a concern over excess nitrates and aquatic biology. When a nitrogen limited eco-system is supplied with high levels of nitrate, significant increases in the levels of phytoplankton (algae) and macrophytes (aquatic plants) can occur. This poses a significant threat to these fragile ecosystems. The recommended levels of nitrates to avoid the propagation of algal blooms is between 0.1 to 1 mg/l (NOAA/EPA).

As the major environmental release of nitrate arises from its use in fertilizers, it is unlikely that the nitrate problem will disappear anytime soon. Thus, there will be a continued need to monitor nitrates in finished drinking water, watersheds, industrial wastewater, private wells and estuaries. Additionally, nitrate contamination of source water will always be a concern for industries that depend on water purity for the manufacturing of their finished product. The data related to nitrate as a contaminant demonstrates the scope of the problem:

According to the Toxic Release Inventory database nearly 60 million pounds of nitrate were released into water between 1987 and 1993. An additional 53 million pounds of nitrate was released into land over this same period. Nitrate is highly soluble and only weakly retained by soils, such that a large portion of the nitrate released to the ground will eventually end up in the water.

According to the EPA there were 14,000 measurement/recording violations for nitrate in the fiscal year 2000. These involved over 11,000 systems and affected over 4 million citizens. Similar numbers were recorded for the years between 1997 and 1999.

According to the EPA statistics regarding nitrate violations, for the fiscal year 2000, there were 804 violations occurring in 457 sites affecting a popu lation of approximately 460,000 people with nitrate levels that exceeded the maximum contaminant level (MCL).

The number stated above for nitrate violations does not reflect the additional potential for exposure to elevated nitrate levels in the more than 15 million private wells in the United States. A 1992 survey conducted by the Office of Pesticides and Toxic substances of the EPA, estimated that 22,000 infants less than one year of age had well-water that exceeded the 10 ppm standard.

It is therefore imperative to develop a reliable, sensitive and selective device to monitor drinking water for nitrate ions. There are a number of commercially available kits for measuring nitrate. These kits utilize a variety of sensing technologies. The EPA Office of Ground Water and Drinking Water maintains a database of approved analytical methods for drinking water compliance monitoring. The methods currently approved for monitoring nitrates are cadmium reduction, ion chromatography and ion-specific electrodes. It is our belief that none of these approaches provides a measurement technology that is rugged, sensitive and suited to the broad spectrum of water sources that need to be monitored. The most sensitive devices, such as ion chromatography, are not portable or adaptable for field-testing without shipping the samples. While many of the field test kits are portable they introduce the opportunity for operator error, in terms of mixing the reagents and interpreting the results. A survey of current nitrate detection technologies is presented in FIG. 22.

The Safe Drinking Water Act (SDWA) is the main federal law that ensures the quality of Americans' drinking water. Under the SDWA the United States Environmental Protection Agency (USEPA) has established guidelines and standards for drinking water quality. In 1996, Congress amended the SDWA to emphasize the importance of sound scientific assessment of the health risks related to water pollutants and contaminants. Our drinking water has shown remarkable improvements since the SDWA was adopted, however, there are growing concerns about the future of safe drinking water and water resources in the United States.

The cost associated with ensuring the safety of our drinking water is growing and will require a considerable input to upgrade the deteriorating water infrastructure in the United States. Rural and tribal populations in the United States that do not have water that meets current standards. The prospect of increasing cost is an even greater concern to the rural water community, where economics of maintaining a safe water supply are the greatest challenge.

The standards may not be sufficient to ensure the safety of certain vulnerable sub-populations such as the elderly, infants, pregnant women and the immuno-compromised. A University of Iowa study has shown that the incidence of bladder cancer was nearly 3 fold higher for the group of women whose water supply had an average nitrate level of 2.46 mg/L nitrate-nitrogen versus those whose water supply contained an average of 0.36 mg/L nitrate-nitrogen. Alarmingly, this level is below the standard indicated under the SWDA.

There is a heightened concern about the health risks associated with exposure to contaminants such as arsenic, nitrate, heavy metals, disinfection by-products and other agents via drinking water. There is the prospect that even in the face of increasing operational cost to produce safe water that we may need to regulate and monitor even more contaminants.

Effective monitoring is a critical component for providing clean, safe drinking water and protecting our water resources. The technology associated with water monitoring must be upgraded to meet the needs of the water and wastewater industries.

There is a need to increase our overall monitoring capabilities to accurately assess the effectiveness of government sponsored water resource management programs.

To develop cost-effective monitoring and processing technologies that will allow the rural and tribal communities to attain a high standard for their drinking water without taxing their limited economic resources.

To produce devices that emphasize simplicity and multi-contaminant analytical capabilities that will enable the individual operator to work more efficiently. This will eliminate the need for third party testing and concerns over shipping and custody of samples.

Design devices for in-line monitoring with direct data read-out to provide operators with critical information in real-time. This is essential for prompt decision making during critical events such as spills and floods.

The quantitative assessment of single common or trace amounts of nitrate in solution depends primarily on chemical and/or analytical separation and detection technologies. These methodologies often require sample preparation, the use of various reagents and some physical transducer of the final product of the chemistry to provide quantitative information. Examples of physical transducers include optical detection, electrochemical, and a broad number of physical detection modes. See Riedel, K., 1998, in Ramsay, G. [ed.] Commercial Biosensors, Vol. 148, Chemical Analysis, John Wiley & Sons, NY, pp. 267-294; Kress-Rogers, E. 1997, Handbook of Biosensors and Electronic Noses: Medicine, Food, and the Environment, [ed., Kress-Rogers, E.], CRC Press, Boca Raton. In general, these technologies are time consuming, costly and require skilled operators but can provide sensitive and reliable quantification of specific analytes. Analytical methods that are rapid and perhaps less costly, may not be as sensitive or reliable as transducer methods, but may still meet the detection and/or quantification requirements.

More recently, sensors based upon biological sensing elements have been developed and exploited for detecting and quantifying a broad range of analytes from ions, metals, and small organics to proteins, lipids, nucleic acids and even whole organisms. These elements include enzymes, antibodies, RNA/DNA probes, membrane channels, whole cells, organs and even whole multicellular organisms. These types of sensors are called biosensors in that the sensing element is of biological origin.

Biosensors are monitoring devices composed of two elements, the first of which is the signal capture component that uses a biological entity such as an enzyme, antibody or cell surface receptor. The second part is the signal transduction element that converts the biological response into a measurable signal like fluorescence, electric current or potential. Biosensors have been described for the determination of more than thirty different environmentally relevant compounds (Riedel, 1998).

Biosensors can achieve the same or greater selectivity and sensitivity as analytical methods, and many allow detection and/or quantification in the absence of reagents and sample preparation, and most often do not require a skilled operator. Because the sensing element in a biosensor is typically very small and because detection is based upon molecular recognition of individual ligand molecules, biosensor devices can be very small and portable, thereby greatly expanding the utility and application of sensing and monitoring technologies.

Biosensors for a broad range of analytes including environmental contaminants and analytes relevant to industrial processes, medical diagnostics and law enforcement have been reported in the scientific and patent literature, though only a few technologies have obtained commercial success to date. See Riedel, K., 1998, in Ramsay, G. [ed.] Commercial Biosensors, Vol. 148, Chemical Analysis, John Wiley & Sons, NY, pp. 267-294; Kress-Rogers, E. 1997, Handbook of Biosensors and Electronic Noses: Medicine, Food, and the Environment, [ed., Kress-Rogers, E.], CRC Press, Boca Raton; Scheller, F. W. and Pfeiffer, D. 1997, in id; Urban, G. 1997 in id.

Enzyme-based biosensors that exploit oxidoreductases have been described. Nitrate reductase (NR), an oxido-reductase, from a variety of sources (bacteria, fungi, and vascular plants) has been used to assay nitrate in environmental or medical samples, in biosensor applications and in bioremediation applications. Nitrate reductases (NR) from different eukaryotic genera (yeast, algae, vascular plants) all share a common subunit structure and a catalytic function—the reduction of nitrate (NO₃-) to nitrite (NO₂—). A number of amperometric sensors exploiting various nitrate reductases have been described. As in any amperometric sensor, the Faradic current derived from the redox reaction at the electrode is measured. Glazier, S. A., Campbell, E. R. and Campbell, W. H. (1998, Anal. Chem. 70:1511-1515) generated an NR-based nitrate sensor that exploits a vascular plant (corn) NR and glassy carbon electrodes for the measurement of nitrate in buffered solutions.

Amperometric biosensors have been developed to take advantage of the redox properties of enzymes. In some applications, the enzymes may be maintained in solution on the surface of the electrode by using a semi permeable membrane, or they may be immobilized onto the surface of the electrode either covalently through some cross-linking chemistry or entrapped in a cross-linked matrix which adheres to the surface of the electrode. In the latter case, the matrix may be a protein or sol-gel, while in other it may be a conducting polymer that can serve to provide and enhance the electrical continuum between the redox centers of the enzyme and the electrode.

Moretto et al. (1998, Anal. Chem. 70:2163-2166; Ramsay, G. and Wolpert, S. M. 1997, Polymeric Mat. Sci. Engineer. 76:612-613) used an ultrathin film composite membrane technology to generate a nitrate biosensor. An ultra thin film of 1-methyl-3-(pyrrol-1-methyl) pyridinium tetrafluorborate was polymerized on an alumina support membrane, which has been coated with a film of gold. This film blocked the loss of methyl viologen, the electron donor to NR, and the free solution of Aspergillis sp. NR while allowing anions (e.g., nitrate) to flow freely to the enzyme. The enzyme activity was coupled to a glassy carbon electrode for amperometric assessment of nitrate levels in buffered solutions and in buffered natural water samples. In all cases where NR was “wired” with alkylpyrroleviologen-based redox polymers, enzyme activity was low. More recently, it has been demonstrated that such redox polymers and even the monomers in solution strongly (>90% loss of activity) inactivate NR (Ramsay and Wolpert, 1999, Anal. Chem. 71:504-506

Essentially all enzyme-based NR biosensors described to date lack stability, ruggedness or real-world applicability. In general, they show very limited periods of operational activity, from a few hours to a couple of days even under laboratory conditions. Lack of long-term stability and functionality typically has been ascribed to enzyme instability, loss of required enzyme mediators or both. Though numerous attempts have been made to overcome these features that limit their practical utilization and commercialization, we believe the present invention overcomes the bulk of the shortcomings of the existing technologies.

Enzyme-based amperometric sensors generally suffer from several major limitations: 1) traditional methods of electrode preparation with each of the three electrode cells comprised of different materials make modeled performances difficult to derive, 2) insufficient enzyme availability/high cost of enzyme preparation, 3) instability of enzyme and/or mediators under ambient conditions, 4) inadequate transducers for reporting enzyme activity, 5) inefficient enzyme immobilization or coupling to electrode, 6) end-product inhibition, and 7) enzyme specificity lacking, 8) a high cost of production and/or multiple steps in preparation. Additionally, in situ aqueous sensors suffer from biofouling on the sensing surface, thus reducing sensor effectiveness.

The inherent fragility of biological systems is a difficulty that has plagued the growth of the biosensor industry. As noted above, purified proteins such as cell-surface receptors, enzymes, antibodies have very limited lifetimes and often cannot withstand the harsh conditions required of some environmental monitors. The fact that many proteins require specific conditions and co-factors for robust activity severely hinders their broad application. The use of chemically synthesized mimics as surrogates for the biologic entities is one solution to these problems. Technologies such as combinatorial chemistry and molecularly imprinted polymers (MIPs) are a few examples where chemical alternatives to biological reagents are employed (Baldino, 2000; Lee and Schneider, 2001; Lehn and Eliseev, 2001; Cheng et al., 2001 and Piletsky et al., 2001). In addition to extending the lifetime of the sensor and widening their potential applications, chemical based sensors are cheaper to manufacture and are more amenable to automated production. This invention specifically relates to using chemical systems to mimic active site chemistry as an alternative to enzyme-based monitoring devices.

Certain biosensors employ as their signal capture element a particular class of protein known as an enzyme. Enzymes are catalysts; they increase the rate at which chemical reactions take place. As a result, they are favored for use in broad range of analytical techniques and monitoring devices. The key component to any enzyme is the “active site”, a domain where the chemical reaction (catalysis) occurs. Recent advancements in the fields of X-ray crystallography and molecular biology have significantly increased our understanding of active site chemistry. Crystallographic analysis provides a three-dimensional picture of the enzyme that often reveals the basic mechanism of the chemical reaction. These high-resolution structural maps can be used to highlight amino acids that are critical to the reaction based on their location and chemical properties.

When crystal structures are not available, there are other ways to study the active site of an enzyme. It is sometimes possible to generate a computer model using the crystallographic data of a related protein. Additionally, there is a vast amount of genetic information, available in the various genome databases, that makes it possible to analyze the protein sequences for a similar enzyme that has been isolated from a different organism. Enzymes with similar functions will often rely on similar amino acids to achieve the catalysis. By comparing the amino acid and nucleotide sequences for a large number of genes, one can often identify those amino acids that are essential for the catalytic mechanism as they are conserved throughout evolution. This approach can greatly simplify the complex chemistry associated with an enzymatic reaction and reduce it to few crucial elements. The pharmaceutical industry uses this type of approach to fabricate “designer proteins” that can bind to an active site and modulate the activity of the enzyme. As we will discuss below, we are using a similar approach to reduce complex enzymatic reactions to their minimal components and replacing these biological components with chemical entities to produce cost-effective, sensitive and rugged environmental sensors.

The modeling of active site chemistry (MASC) technology of the present invention was developed as part of an overall biosensor effort. As a by-product of evolution, many organisms have developed highly sensitive and selective mechanisms for sensing and responding to their local environment. Adapting these sensory mechanisms into electronic monitoring devices represents an ideal technology for environmental monitoring. The principle behind the invention is to reproduce the key features of enzymatic active sites using chemical rather than biological entities

This technology is not limited to producing chemical mimics of enzymes but could also be employed to reproduce any functional domain within a protein, such as a binding site. There are several advantages to this technology. First, using chemical compounds extends both the active life and shelf-life of these detectors. Chemical synthesis is much more amenable to manufacturing and production. The cost for producing these sensors would make them more cost-effective than the devices currently employed in the water and wastewater industries.

### SUMMARY OF THE DISCLOSURE

The present invention overcomes the aforementioned limitations by providing an amperometric sensor design, for the detection of analytes, using a synthetic polymer instead of an enzyme substrate as its sensing element. The sensing element of the sensor is modeled after functional aspects of an enzyme or peptide of interest. The functional aspects are then reproduced as synthetic substrates for use in the sensing element of the invention.

In one preferred embodiment of the present invention, the sensing element is based on the interaction of a dioxo-compound, such as the molybdenum-molybdopterin group found in nitrate reductase, with an amino-group which functions to stabilize the nitrate anion, while immobilized together in a medium.

In an example of a preferred embodiment of the sensor design for the detection of nitrate as an analyte, a noble metal substrate or electrode is chemically modified with a readily hydrolyzed organic solvent and then immobilized in a matrix. For example, it is preferred that the metal substrate consists of gold, and is chemically modified with molybdenum(VI) dichloride dioxide (MoO₂Cl₂) as the organic solvent, immobilized in an organosilicon clay matrix. The organosilicon clay is synthesized using a silane with methoxy-groups, which can readily be hydrolyzed to form a polysiloxane polymer. Preferably, the clay is synthesized by hydrolysis of an amino-containing methoxy-, dichloro-silane such as 3-aminopropyltrimethoxysilane, or generally an amino-containing silane having readily hydrolyzable groups such as chlorine-, methoxy- or ethoxy-groups in an alcohol, such as 2-propanol. The hydrolyzed silane containing clay solution is stirred continuously under aerobic conditions for several hours, after which, it can immediately be used for electrode coating or stored for later use.

Other objects of the invention include a sensor device which incorporates the sensor design, described above, along with associated housing, electronics and read out devices for detecting analytes in solution.

Preferably, the device comprises a carrier and electrodes disposed on the carrier. In particular, a dot electrode is disposed on said carrier. One or more sensing elements are disposed upon the dot electrode. The sensing elements are reactive to a test substance. A second electrode is disposed on the carrier, and is concentrically arranged around the dot electrode. A third electrode is disposed on the carrier, and is concentrically arranged around the second electrode. Embodiments of the device, described in examples below, uniquely provide uniformity in sensor-to-sensor electrode production as well as a low-level reference potential and, therefore, a low sensor-to-sensor ambient current variability.

Objects of the invention include providing a biosensor with:

A concentric design of electrodes that yields a uniform driving electrical field;

Long-term performance stability, which allows for ‘hands free’ long-term, accurate and selective monitoring of nitrate levels in aqueous solutions;

Operation in a continuous flow-through mode or on-demand, single sample (discrete measurement) mode, or single flow-through measurement;

Rugged format;

An electrode design that can be uniformly mass produced at a low cost, with little or no variation in performance from sensor to sensor, as well as a low-level reference potential, and low sensor-to-sensor ambient current variability;

An electrode design in which the circuitry can be co-located with the electrodes;

Electrode material that is stable in fresh water, waste-water and a broad range of aqueous solutions; and

A surface on which the electrodes are placed having virtually any geometry.

Still further objects of the invention include providing a sensor that detects and quantifies substances relevant to public health, industrial and commercial processes, and to environmental protection. Yet another objective of the invention is to provide a sensor that is easily modified for different sampling regimes that can be amperometrically reported directly or indirectly. The invention also achieves the objective of providing a device that is easily formatted as a stationary device, portable device, expendable device, or as a one-time-use device.

Another aspect of the invention provides methods for using the devices of the invention to detect and measure biochemical substances. The methods comprise the steps of causing the sensing elements of the device to be exposed to a solution of interest, and a step of monitoring responses of the sensing elements. Thus, further objects of the invention are achieved, such as provision of methods which easily adapt to analyte detection and measurement in drinking water systems, process stream systems, environmental analysis and monitoring, pharmaceutical research, medical diagnostics, as well as other biochemical applications.

All of the foregoing operational principles and advantages of the present invention will be more fully appreciated upon consideration of the following detailed description, with reference to the appended drawings.

### BRIEF DESCRIPTION OF THE DRAWINGS

FIG. 1 is a block diagram of a preferred embodiment of a sensor system according to the invention.

FIG. 2 is a perspective view of a preferred embodiment of a biosensor device according to the invention, including a sensor cartridge in partial cross-section and a con tainer for associated electronics and read-out of re sults.

FIG. 2a is a blow-up of the electrode configuration of FIG. 2.

FIGS. 2b and 2c are individual views of the sensor cartridge system and control box, respectively.

FIG. 3 is a perspective view of the sensor cartridge.

FIG. 4 shows the top of the sensor cartridge of FIG. 3 in a perspective view.

FIG. 5 is a bottom view of the sensor cartridge of FIGS. 3 and 4 showing the power supply and signal output side of the cartridge.

FIG. 6 is a cross section of the sensor cartridge of FIG. 2.

FIG. 7 is an enlarged top view of the sensor cartridge of

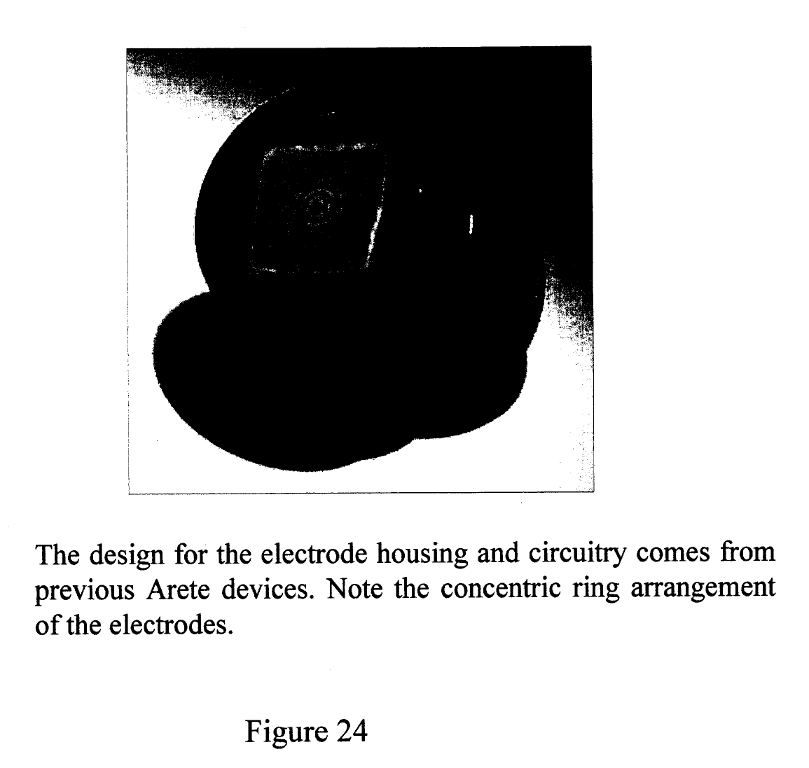

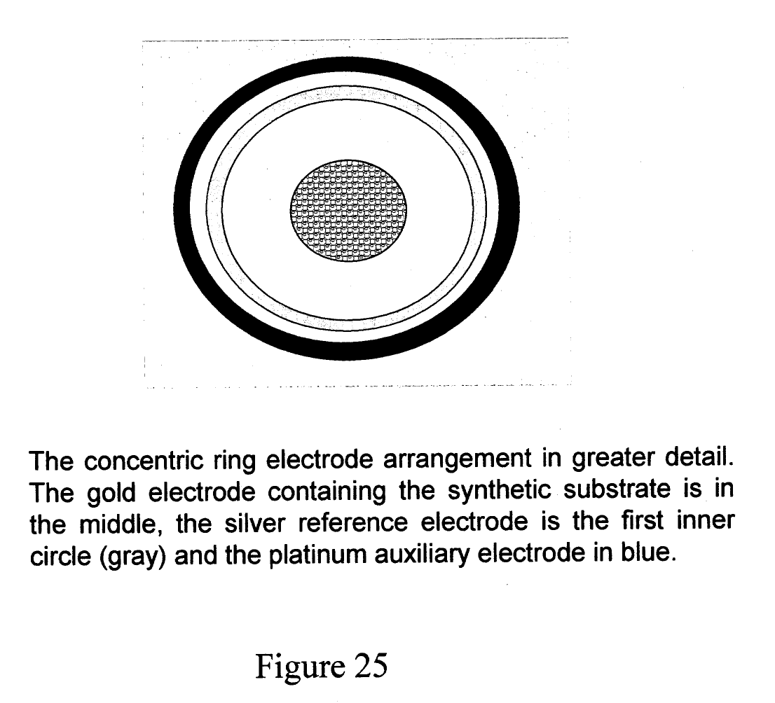

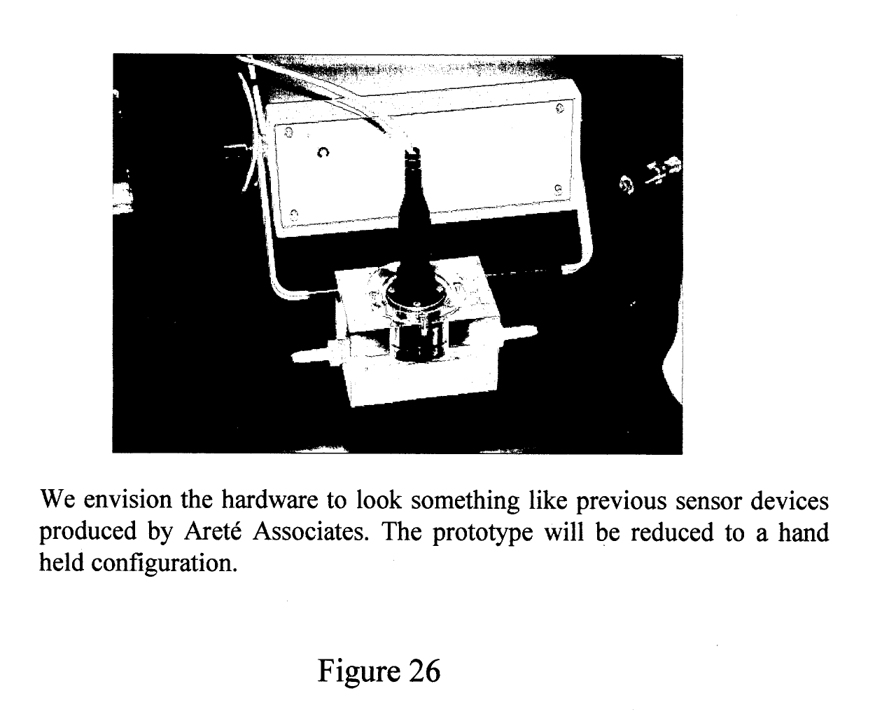

FIG. 6, showing the electrode side of the chip of the sensor cartridge shown in FIG. 6.

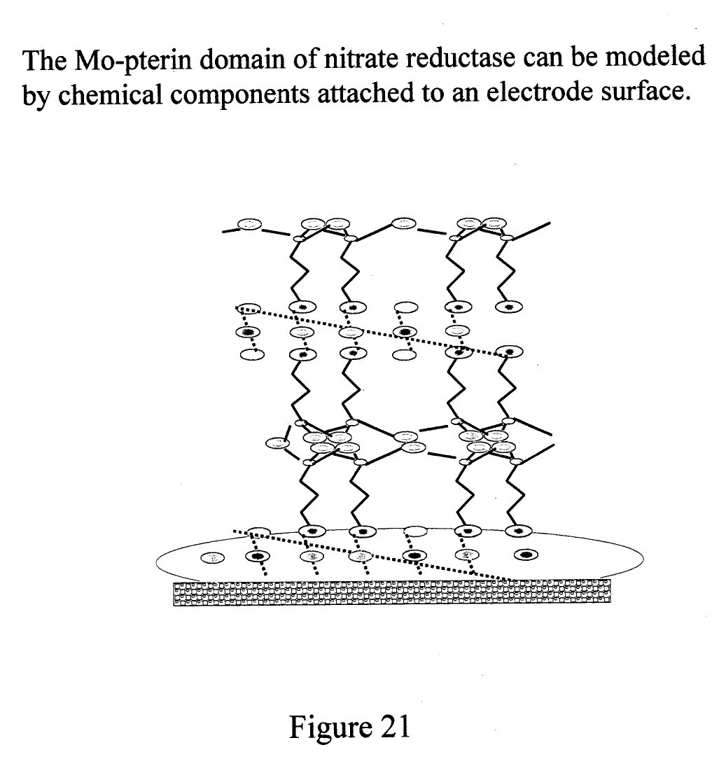

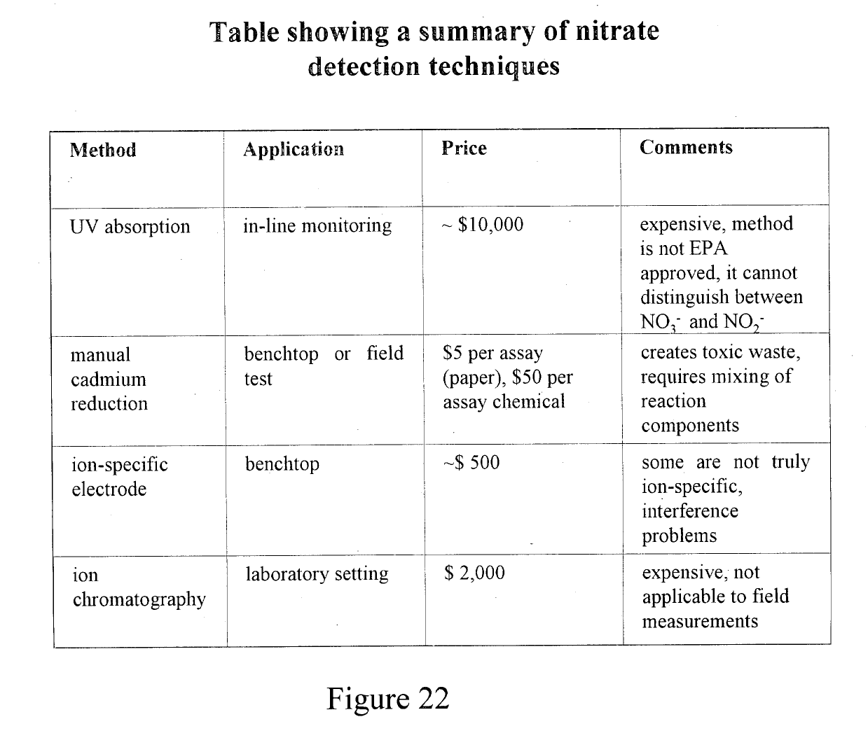

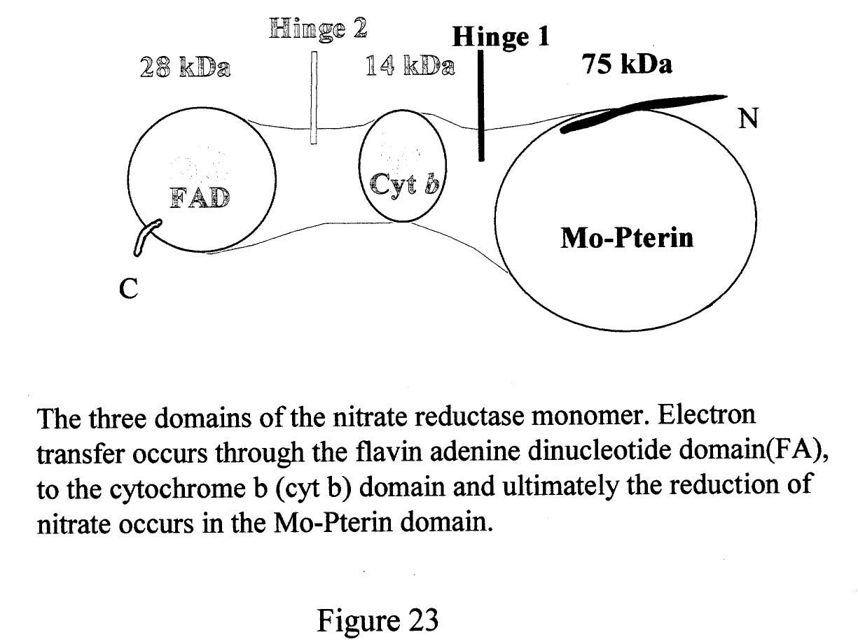

FIG. 8 is a view of the electronics attached to the rear of the chip shown in FIG. 5.

FIG. 9 is a circuit diagram of the electronics shown in FIG. 8.

FIG. 10 is a schematic representation of the arrangement of aminopropylsiloxane sheets on the electrode with intercalated molybdenum coordinated to oxygen and hydroxyls.

FIG. 11 is a graph of data obtained using a preferred embodiment of the sensor of the invention showing the reduction of nitrate monitored by pulse voltammetry.

FIG. 12 is a graph of data obtained using a preferred embodiment of the sensor of the invention showing the reversibility of nitrate reduction by cyclic voltammogram of gold modified with APS/MOO₂Cl₂.

FIG. 13 is a graph of data obtained using a preferred embodiment of the sensor of the invention showing a linear increase in current density with increasing nitrate levels.

FIG. 14 is a graph of data obtained using a preferred embodiment of the sensor of the invention showing the changes in current observed upon addition of nitrate.

FIG. 15 is a graph of data obtained using a preferred embodiment of the sensor of the invention showing the changes in current observed upon addition of nitrate at submillimolar concentrations.

FIG. 16 is a graph of data obtained using a preferred embodiment of the sensor of the invention showing logarithmic increases in peak potential with increasing nitrate levels.

FIG. 17 is a graph of data obtained using a preferred embodiment of the sensor of the invention showing the exponential increase in peak potential with increasing nitrate concentrations.

FIG. 18 is a graph of data obtained using a preferred embodiment of the sensor of the invention showing the response of the film to nitrate in bi-distilled water.

FIG. 19 is a graph of data obtained using a preferred embodiment of the sensor of the invention showing the response of the film to nitrate in the presence of nitrite.

FIG. 20 is a schematic representation of the potential mechanism for nitrate binding to the molybdenum in the organosilicon clay matrix.

FIG. 21 is a schematic structural diagram showing the Mopterin domain of nitrate reductase.

FIG. 22 is a table showing a summary of nitrate detection techniques of the prior art.

FIG. 23 is a structural diagram showing the three domains of the nitrate reductase monomer.

FIG. 24 is a picture of a preferred design for the electrode housing and circuitry.

FIG. 25 is an enlarged depiction of the electrode configuration.

FIG. 26 is a photo of a preferred design for the sensor device hardware.

FIG. 27 is a table describing analytes and the accompanying active-site chemistry for the purpose of illustrating examples of some preferred embodiments of the invention.

FIG. 28 is a graph of data showing that the responsiveness of the electrode of the invention is unaffected by high levels of certain specified contaminants.

FIG. 29 is a table describing sensor device formats for the purpose of illustrating examples of some preferred embodiments of the invention.

FIG. 30 is a table describing sensor device formats and applications for the purpose of illustrating examples of some preferred embodiments of the invention.

FIG. 31 is a table describing sensor dimensions for the purpose of illustrating examples of some preferred embodiments of the invention.

### DETAILED DESCRIPTION OF THE PREFERRED EMBODIMENTS

As used herein, the term “biosensor” refers to the device or device of the invention which comprises an analytical device that incorporates a sensing element based on a synthetic substrate. The synthetic substrate is the portion of the sensor designed to mimic the active-site chemistry of an enzyme or functional peptide in order to specifically react with an analyte or ligand of interest. The synthetic substrate is in intimate contact with an appropriate transduction element for the purpose of detecting—reversibly and selectively—the concentration or activity of chemical species (analytes) sampled by the biosensor from aqueous (liquid) phase or solution. Biosensors use catalysis and affinity interactions, generally using agents derived from biological systems or recombinant biological systems. In the present invention, the biosensor uses agents that are synthetically derived from such biological systems. The term “biosensor” also refers to a self-contained analytical device that responds selectively and reversibly to the concentration or activity of one or more chemical species, analytes or ligands in biological samples. Accordingly, the device of the present invention comprises a biosensor for practical applications in medicine, environmental protection, and process stream monitoring in various industrial applications such as food or beverage processing.

As used herein, the term “aqueous solution” is used to refer to a candidate aqueous material that might or might not contain an analyte that the methods and device of the invention are detecting. In other words, analyte is the chemical entity the methods or device is looking for, and the aqueous solution is the material in which the methods or device are looking for it. Another definition of the term “analyte” as used herein is a molecule capable of being bound by the sensing element, i.e. bound by the active-site chemistry of the synthetic substrate. The analyte may be chemically synthesized or may occur in nature.

As used herein, the term “contaminant” means any analyte considered to be unacceptable to the system or medium, which substance could include toxicants (toxic agents) or other substances that are not toxic under normal environmental conditions, but due to their elevated concentrations can be hazards or nuisances to human health or environmental stability.

A “sensing element” is defined to be comprised of a synthetic substrate that when activated by the binding of a chemical ligand or specific analyte, in turn, causes one or more electrons to flow between the sensing element and the analyte, and operates to communicate an electrochemical signal (analytes, ligands or specific substances) from the aqueous environment through the biosensor device of the invention to be displayed to the user of the device. Concomitant with the binding of the analyte to the sensing element is a flux of electrons to the sensing element from the electrode with which the sensing element is in electrical contact, that is, a signal, which, when processed or monitored by the device of the invention indicates the presence or concentration of an analyte of interest in the aqueous solution of interest.

The sensing elements of the invention are capable of detecting natural and synthetic molecular species (analytes). In principal, the range of chemical structures that can be detected by sensing elements in the device and methods of the invention are unlimited (-Rogers, E. 1997, Handbook of Biosensors and Electronic Noses: Medicine, Food, and the Environment, [ed., Kress-Rogers, E.], CRC Press, Boca Raton).

It will be understood that the term “sensing element” is used to include (1) a single synthetic substrate for a single analyte; (2) a plurality or array of different synthetic substrates specific for a plurality of specific analytes respectively; (3) a plurality or array of different synthetic substrates specific for a single analyte.

As used herein, the term “noble metals” refers to the unreactive metals that are not readily dissolved by acids and not oxidized by heating in air. The noble metals are generally considered to be gold, silver, platinum, palladium, iridium, rhenium, mercury, ruthenium, and osmium.

The practice of the present invention will employ, unless otherwise indicated, standard techniques, materials, and equipment in biosensors, and electronics for detecting, monitoring, and processing electrical characteristic changes of sensing elements. Factors, techniques, and equipment involved in biosensor construction, performance and application of biosensors to health care, control of industrial processes, environmental monitoring are explained fully in the literature. The electroanalytical methods of potentiometry, voltammetry and conductivity, chip and biosensor system device construction are disclosed and explained in standard references. Also available in the literature are methods for optimizing performance factors: selectivity, linear range, calibration, reproducibility, response time, life time and the factors affecting biosensor performance (See, e.g., Janata, J., Principles of Chemical Sensors, (1989), Plenum Press; Eggins, B. R., Biosensors—An Introduction, (1996), John Wiley & Sons Ltd.; Kress-Rogers, E., ed., Handbook of Biosensors and Electronic Noses, Medicine, Food and the Environment (1997), CRC Press; Fraser, D. M., Biosensors in the Body: Continuous in Vivo Monitoring, (1997), John Wiley & Sons; Bickerstaff, G. F. ed., (1997) Immobilization of Enzymes and Cells.

Biosensor Device

An essential element to the application of our approach is a basic understanding of the protein to be modeled. To demonstrate the feasibility of our approach we chose to model the active site chemistry for the enzyme nitrate reductase, as a means of developing a nitrate sensor. This implementation of the present invention is described in detail by incorporation of materials previously deposited in the Patent and Trademark Office on May 25, 2001 as a copending and coowned provisional application entitled, Nitrate Anperometric Sensor for Nitrate Detection Using a Synthetic Substrate, by inventors Pilloud, McGowan, Farruggia, and Morris, attorney docket code number xAA-41; herein incorporated in its entirety by reference. It is also summarily described in this application as follows.

In nature, for the synthesis and utilization of proteins and nucleic acids, the sources of nitrogen are provided by two major pathways: nitrate assimilation and nitrogen fixation. Nitrate assimilation by higher plants, algae, fungi, yeasts and bacteria is significantly more important than nitrogen fixation. Nitrate assimilation is achieved by the enzyme nitrate reductase (NR), which reduces nitrate to nitrite (NO₂⁻). Accordingly, the nitrate reductase enzyme catalyzes the following reaction:

NO₃⁻+NADH à NO₂⁻+NAD⁺+OH⁻

In the reaction nitrate is reduced to nitrite and nicotinamide adenine dinucleotide (NADH) is converted to its oxidized form, NAD⁺. The reaction is essentially irreversible (DG=−34.2 kcal/mol) and is the rate-limiting step for the acquisition of nitrogen for most plants, algae and fungi (REF: Campbell, 1999). The nitrate reductase enzyme is a homodimer containing two identical subunits ranging from 100-145 kDaltons depending on the source organism. Each nitrate reductase monomer is composed of three distinct domains; the flavin adenine dinucleotide (FAD), the heme and molybdenum domains as shown in FIG. 23. Electrons are transferred through a series of reactions beginning with the FAD region, passing through the heme center and terminating in the molybdenum-containing region.

The active site for nitrate binding and reduction is located in the molybdenum-containing domain as shown in FIG. 21. The other domains shown in FIG. 23 function primarily to donate the electrons that ultimately serve to reduce the nitrate. It has been shown that these other domains are not necessary for the reduction of nitrate to occur, provided that a secondary source of electrons, such as bromo-phenol blue or methyl viologen, is added (Kubo, et al., 1988; Solomonson and Barber, 1990; Mertens et al., 2000)

Although, the crystal structure of nitrate reductase remains unresolved, the active site described above was uncovered based on the known structures for several related molybdenum-containing enzymes (Boyington et al., 1997; Schindelin et al., 1996; Romao et al., 1995; Schneider et al., 1996). The bacterial nitrate reductases can be classified either as membrane-bound, cytoplasmic or periplasmic according to their cellular location. Sequence comparisons among these three classes reveal some distinctions in their amino acid sequences that are directly related to functional differences among the different nitrate reductase sub-classes (Blasco et al., 1990; Wootton et al., 1991; Berks et al., 1995; Trieber et al., 1996). From this combination of structural modeling and sequence analysis a picture of the active site chemistry for the nitrate reductase enzymes emerged. It has been reported that a cluster of cysteine residues located near the active site play an essential role in mediating electron transfer in the enzyme. Cysteine residues contain free sulfhydryl groups in their side chains that allows them to enter into thiol linkages. Their role in the reduction of nitrate comes from their ability to bind iron through forming iron-sulfur [Fe-S] pairs, where the iron is involved in the transfer of electrons (Garde et al, 1995). Magalon and co-workers, performed extensive analysis of the E. Coli nitrate reductase active site. This group was particularly interested in the role played by a specific histidine residue located at amino acid site 50 of the E. Coli nitrate reductase. In other nitrate reductases this residue is one of the cysteines (mentioned above) that is involved in binding iron. They discovered, however, that in the E. Coli enzyme, this residue is required to adjust the coordination state of the molybdenum during the reduction reaction cycle (Magalon et al., 1998). Using electron paramagnetic resonance (EPR) they showed that the molybdenum shuttled through coordinations of state 5 and 6 during the reaction. These results allowed us to reduce a complicated enzymatic reaction to its key active site components: a molybdenum metal that can shuttle between +5 and +6 coordinations, sulfhydryl containing amino acids to form [Fe—S] clusters, a protein scaffold to maintain those components and provide a stable reaction center and a source of electrons to drive the reduction reaction. The present invention reproduces these elements using chemical components as substitutes in producing an electrode that is specific for nitrate ions.

The design of the chemical sensor of the present invention is based on a minimalist approach. Because the active site where this reaction occurs is composed of a molybdenum-molybdopterin group (MPT) ^{[1]}, first, the elements of the MPT essential to its functionality are selected, then the construction of a crude artificial active site for nitrate reduction can be undertaken. The critical elements of the MPT that were selected include: (1) a dioxo-compound, such as molybdenum with a coordination number of six and bound to oxygen; (2) amino-groups to stabilize the nitrate anions; and (3) a matrix to replace the protein medium, in order to provide specificity, robustness and reproducibility. [1] W. H. Campbell, Annu. Rev. Plant Physiol. Plant Mol. Biol. 1999, 50,277-303.

To satisfy the first point, molybdenum(VI) dichloride dioxide (MoO₂Cl₂) was chosen because the Mo has a coordination of six, is bound to oxygen, and in presence of water is readily hydrolyzed, allowing the replacement of the chlorines by other ligands (such hydroxy-groups). Furthermore, MoO₂Cl₂ is soluble in organic solvents. To fill the second and third criteria, 3-aminopropyltrimethoxysilane (APS) was chosen primarily because it contains silanes with methoxy-groups that are readily hydrolyzed to form a polysiloxane polymer. The polysiloxanes self-assemble into sheets, adopting a structure similar to naturally occurring smectite clays such as montmorillonite ^{[}2]. Secondly, it was chosen because the amino group of the APS are protonated in the first steps of the hydrolytic condensation to form —NH₃^{+[ ]}. This positively charged group was expected not only to stabilize the binding of the negatively charged nitrates, but also to contribute to the specificity of the film by avoiding the presence in the film of cations. Another function of the —NH₃⁺ was to facilitate the binding of MoO₂Cl₂, by interacting with the Mo directly or with its ligands (oxygen, hydroxyls, water). The structure of the APS is as follows. [2] A. Szabó, D Gournis, M A. Karakassides, D. Petridis, Chem. Mater 1998, 10. 639-645.

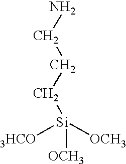

FIG. 21 shows a schematic representation of the arrangement of aminopropylsiloxane sheets on an electrode with intercalated molybdenum coordinated to oxygen and hydroxyls.

While the successful application of the invention does not depend on knowledge of the exact mechanism of the nitrate reduction, it is believed that nitrate affinity for the film may be caused by the binding of nitrate anions to the molybdenum and protonated amino groups, thereby replacing hydroxyl ions as in FIG. 20. Some possible mechanisms include:

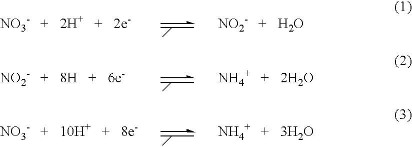

Equations 1 and 2 show nitrate first being reduced to nitrite (Eq. 1), and then further being converted to ammonium (Eq. 2). Equation 3 combines Equations 1 and 2 for the reduction of nitrate to ammonium. Although, the mechanism of Equation 3 requires ten protons, it is made possible by the strongly acidic character of clays. A better understanding of the exact mechanism can be elucidated by chemical analysis of the nitrate solution after electrolysis.

While the active-site chemistry of the enzyme nitrate reductase was examined to demonstrate the methodology of the invention, the invention is not limited to this example. The invention can be modeled after a wide variety of enzymes and proteins to mimic their active-site chemistry. A few preferred examples of enzymes and chemical systems to be modeled are described in FIG. 27. Although the present sensor device can be applied to any number of chemical systems, FIG. 27 illustrates six examples of such systems accompanied by references to literature containing further details of their respective active-site chemistries. It is also envisioned that the sensors may include analytical capabilities to detect multiple analytes. This type of sensor would be especially useful in the water monitoring profession.

Methodology:

A preferred embodiment of the sensing system according to the invention is directed to a nitrate amperometric sensor based on the chemical modification of a gold substrate with molydenum(VI) dichloride dioxide (MoO₂Cl₂) immobilized in a matrix of organosilicon clay. The clay is synthesized by hydrolysis of 3-aminopropyltrimethoxysilane in an alcohol, specifically 2-propanol. The solution is stirred and kept under aerobic conditions in a sealed container for at least overnight. The solution can be used for electrode coating or can be stored for use as needed to build more film. The following demonstrates one embodiment of the process in more detail.

For the preparation of the polysiloxane polymer, preferably, a range of about 0.01M to 0.02 M of molybdenum(VI) dichloride dioxide (MOO₂Cl₂) is dissolved in alcohol. In the nonlimiting example that follows, 0.015 M of molybdenum(VI) dichloride dioxide (MoO₂Cl₂) was dissolved in 2-propanol. This was followed by the addition of 0.02 M of 3 aminopropyltrimethoxysilane (APS) to the solution, while stirring. The solution adopts a milky appearance immediately after addition of the APS. No water is added. The solution is kept under aerobic conditions, in a tightly closed vial and is stirred continuously for several hours, e.g. at least overnight. The solution is either used as it is for electrode coating, or is subject to further treatment as follows. After centrifugation at 10,000 rpm for 15 minutes, the supernatant solution was separated from the insoluble white precipitate. This precipitate was washed twice with 2-propanol, filtered, and dried under vacuum. It can be resuspended in 2-propanol by sonication when needed to build more films.

Gold electrodes were cleaned by sonication in distilled water for 30 min., followed by immersion in H₂SO₄/H₂O₂ 30%(4:1, v:v) for 15 min, and by sonication in distilled water for 15 minutes. Finally, the cleaned electrodes were dried by flushing with argon. The electrodes were then coated by overnight immersion in the alcohol-clay solution. They were then ready to use after washing with water and equilibration by immersing the coated electrodes in aqueous solution for at least one hour.

Nitrate detection was monitored by the following electrochemical techniques: cyclic voltammetry (CV), differential pulse voltammetry (DPV) and chronoamperometry. The reference electrode was a silver wire. It was calibrated before and after measurements with potassium ferricyanide. The counter electrode was a platinum wire. The working electrode was a gold disk of 2 mm diameter coated with the Mo-clay. The supporting electrolyte was typically 0.1 M potassium chloride, 0.01 M potassium phosphate, pH 7.25. All measurements were performed in air without degassing the solution and without filtration, at room temperature. The solution was, however, stirred prior to each measurement to prevent any reaction gases from inactivating the electrode.

The principle behind cyclic voltammetry (CV) is that the voltage applied to the electrode is swept through a range of values, using defined increments and the current produced across the electrode is measured at all times. When a particular applied voltage is sufficient to promote a transfer of electrons, the movement of the electrons yields a current. This property is governed by the chemical composition of the electrode. In particular, the specific voltage at which the electron transfer occurs (reduction) is a distinguishing feature and characteristic for most compounds. FIG. 11 shows the results of after monitoring using differential pulse voltammetry and FIGS. 13 and 14 show changes in current observed upon addition of nitrate. Addition of nitrate in the supporting electrolyte solution gave rise to a signal at potentials and current densities ranging from −0.8 V to −0.5 V versus normal hydrogen electrode (NHE) and from 0.03×10⁻³ A/cm² to 3×10⁻³ A/cm², respectively, depending on the nitrate concentration as shown in FIG. 13.

Below, the results are presented in function of the following criteria: sensitivity, selectivity, reversibility, reproducibility, and robustness.

Sensitivity: It is essential that a nitrate sensor be able to detect nitrate concentrations below the allowable limit of 10 ppm in order to be useful as a tool for testing drinking or wastewater. FIG. 15 shows linear results for the addition of nitrate at submillimolar concentrations. The upper limit of the analysis was 30 ppm, since toxicity thresholds are reached at that concentration and water containing that level of nitrate is not drinkable. As shown in FIG. 13, the Mo-clay modified electrode under amperometric conditions, exhibits a linear sensitivity to nitrate at levels starting at 3 ppm NO₃-N, up to 100 ppm NO₃-N. The detection of nitrate can also be achieved potentiometrically, since the potential at which the nitrate is reduced depends exponentially on the concentration as shown in FIGS. 16 and 17.

Selectivity: Presence of high concentrations (0.1 M) of potential contaminants such as: nitrite, chlorate, sulfate, ammonium, phosphate, chloride, Mg, as well as of dioxygen, did not affect the measurement of nitrate as seen in FIG. 28. (FIG. 19 shows response of the film in the presence of nitrite in detecting varying concentrations of nitrate. Re-suits of a similar experiment are shown in FIG. 18 where response of the film was tested in bi-distilled water.) Although not necessary to the practice of this invention, it is desirable to know whether the presence of high concentrations of inorganic compounds such as acetate, carbonate, bromide, fluoride, perchlorate, chlorite, hypochlorite, sulfite, or cyanide; as well as organics such as nitroaromatics, phenols, hydrocarbons, pesticides and herbicides affect nitrate measurement. Another optimization of the invention not necessary to its practice, yet desirable to ascertain is the effect of pH and temperature on the nitrate sensor.

Reversibility: The electrode responds to changes in nitrate concentrations in a time scale of milliseconds as observed by chronoamperometry as seen in the FIG. 12 voltammogram results. However, at very high concentrations of nitrate (higher than 0.5 M) the reversibility decreases, and a period of forty-eight hours immersion of the electrode in distilled water is necessary for regeneration.

Reproducibility: Reduction of nitrate does not alter the integrity of the electrode. Even after two weeks, electrodes retain the same responsiveness to nitrate. Five different coated electrodes were tested, using five identical but distinct coating solutions. They each give similar results.

Robustness: No special precaution was taken either for handling or for storage of the coated electrodes. Regardless of storage in water, 2-propanol, or kept dry exposed to air, the modified electrodes did not show any deterioration of their performance on a weekly time scale.

Biosensor Apparatus

The sensor device is amperometric, meaning that its output signal is an electric current. In the preferred embodiment described above, the current is derived from a flow of electrons from an electrode surface, through the molybdenum reaction center to nitrate. The strength of the current is directly proportional to the concentration of the nitrate according to Nernst's equation. The data that we have provided was derived from electrochemical analysis based on cyclic voltammetry. Particularly important to the present invention is that the voltage at which the net transfer between the electrode and nitrate occurs is −1100 millivolts. Thus, in order to produce a circuit that will measure the nitrate reduction one particular applied voltage needs to be sampled. This removes the slow process of cycling through a series of voltages. The magnitude of the current produced at this potential is directly proportional to the concentration of the nitrate, according to Nernst's equation. The produced current, however, can sometimes be too low for conventional electronics and must be amplified through the addition of amplifiers to the circuitry. As a result, to measure nitrate concentration using the present invention, it is only necessary to measure the current produced at a fixed voltage and convert this current to a concentration via a microprocessor. The integrity of the electrode is maintained by alternating the potential between the test potential (−1100 mV) and a reference voltage. This two-step cycling, which occurs on the time scale of milliseconds, allows the electrode to re-charge naturally and prolongs its life span.

Regarding electrode configuration, a substrate, preferably gold, is used to form a dot (working) electrode 36. The dot electrode 36 is a circular disk comprising the synthetic substrate, or as in a preferred embodiment the synthetic substrate is the MoO₂Cl₂/organosilicon clay film. A reference (second) electrode 38 composed of silver and an auxiliary (third) electrode 40 composed of platinum surround the dot electrode 36 in the form of concentric circles. The electrodes 34 are initially formed out of platinum and are then deposited with gold (dot electrode 36), or silver (reference electrode 38), depending on the type of electrode. The gold or silver is deposited onto the platinum using standard methods of electroplating and is followed by polishing of the electrodes 34 until they exhibit a mirror-like surface.

The reference 38 and auxiliary 40 electrodes are constructed in narrow concentric rings around the dot electrode 36, the auxiliary electrode 40 being the outer concentric electrode as shown in FIGS. 24 and 25. The concentric design of the auxiliary and reference electrodes yields uniform driving electrical fields between the auxiliary 40 and working 36 electrodes.

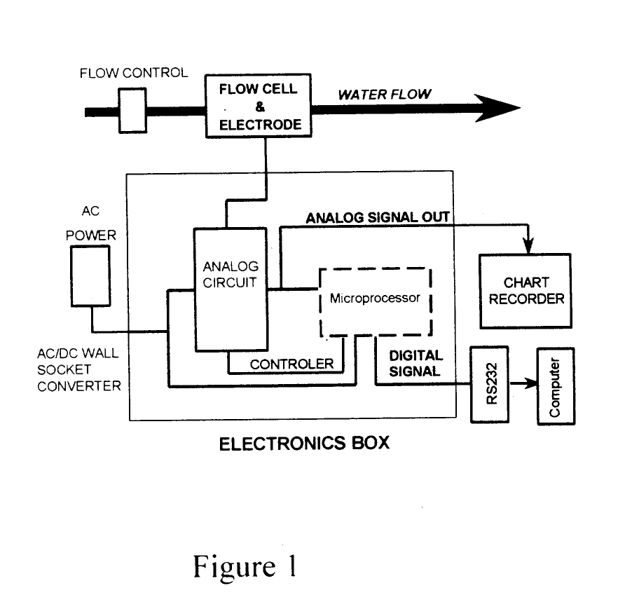

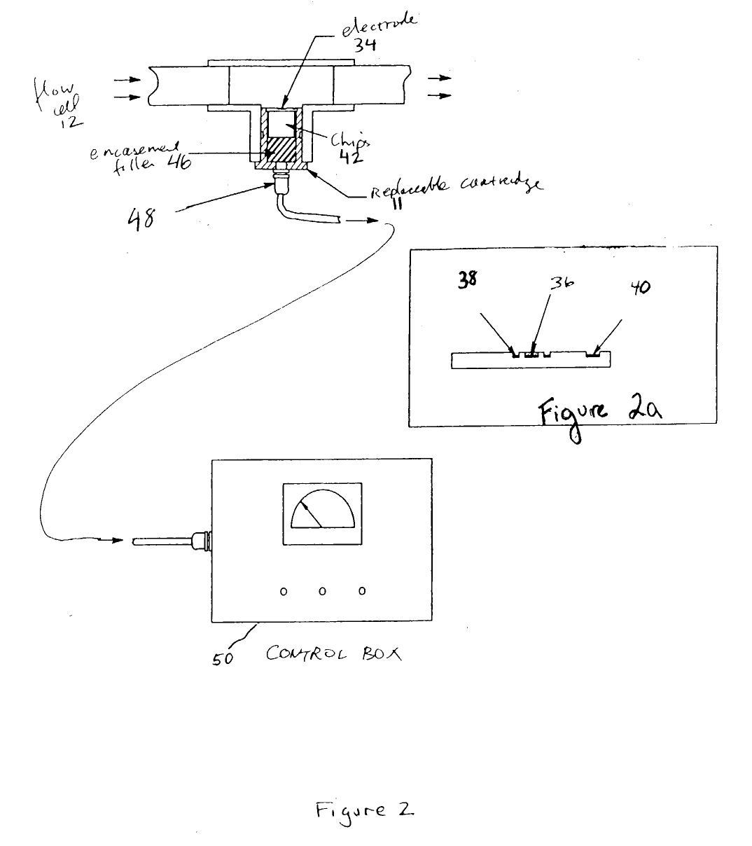

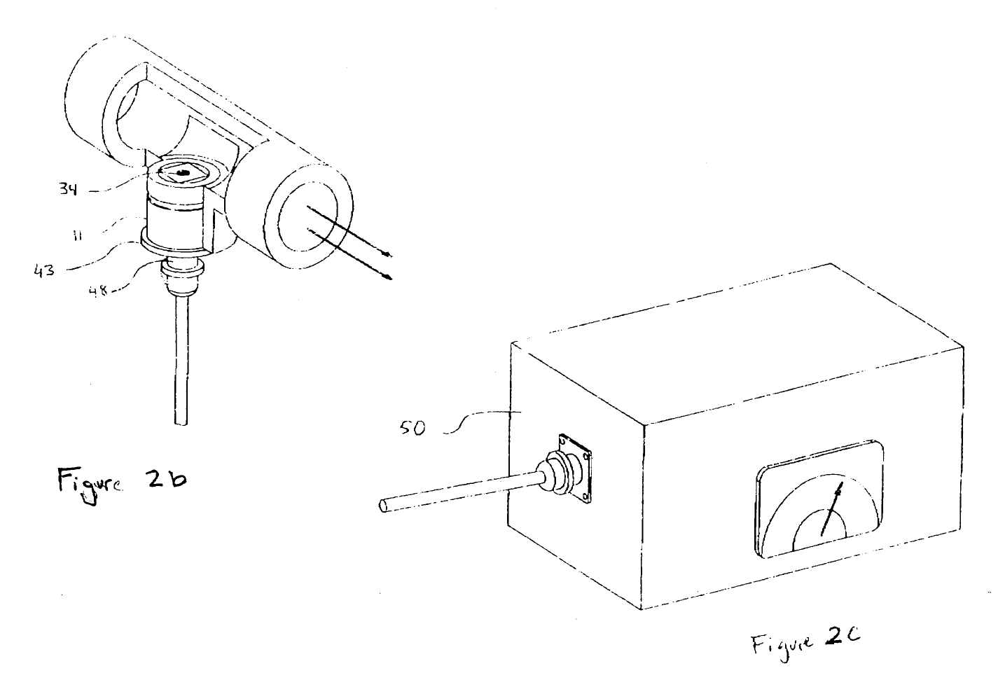

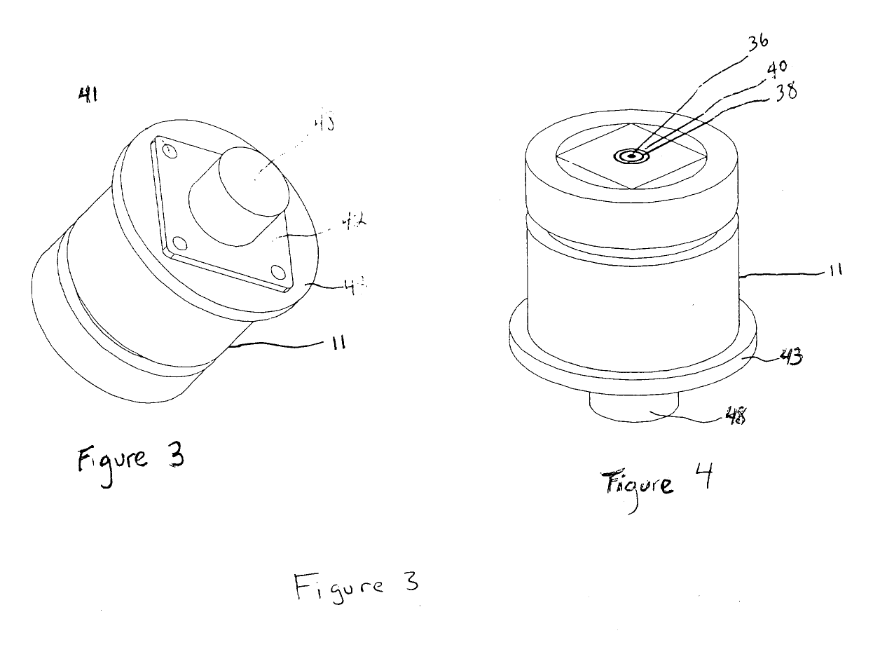

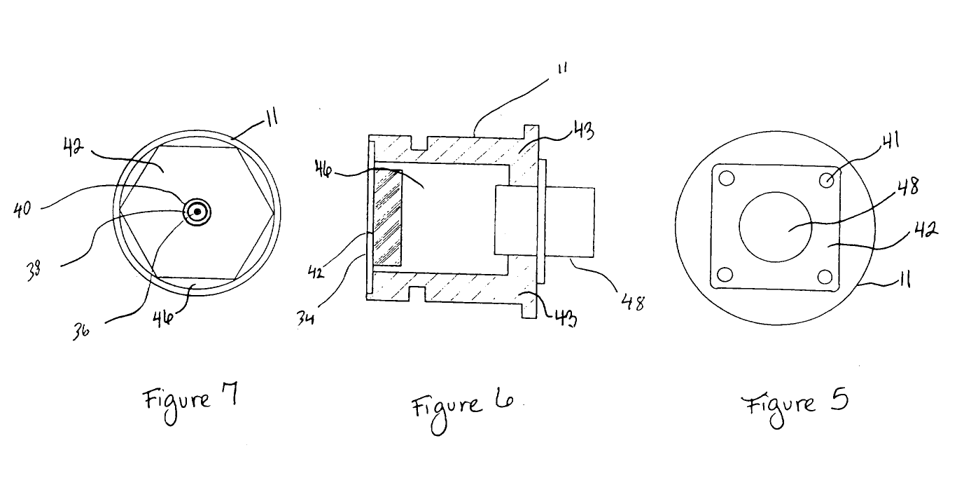

The following is an implementation of the present invention by incorporation of materials previously deposited in the Patent and Trademark Office and described in a copending and coowned provisional application serial No. 60/283,009 by inventors Alberte, Farruggia, and Morris; incorporated in its entirety by reference. This implementation provides an embodiment of the present invention as part of a sensing system or device. A block diagram representing a preferred embodiment of the sensing system according to the invention is illustrated in FIG. 1. The diagram in FIG. 1 shows electrode component 34 of the sensing system as it is connected to a water stream 14, controlled by flow control 10 and an electronics box 18. The electronics box 18 in FIG. 1 is connected to an AC/DC wall socket converter 16, for its power supply and to a chart recorder 32 to record data. The electronics box 18 contains an analog circuit 20 and a tattletale computer 22. This configuration of the electronics box allows it to output both analog 26 and digital 30 signals for use with either analog or digital recording and storage devices and will be discussed in greater detail below. FIG. 26 shows an example of some of the hardware described in FIG. 1 of the preferred embodiment.

The electrodes 34 are connected with vias and pads through a ceramic chip or carrier 42, to which the electrodes 34 are attached, either directly to the electronics on the back-side of the ceramic chip, or through connectors to the electronics. The electrode system of the invention allows for the dot electrode 36 to be either the cathode or the anode depending on the application. These forms of the electrode system achieve +/−0.1 nanoamp sensitivity under appropriate buffer conditions as described herein.

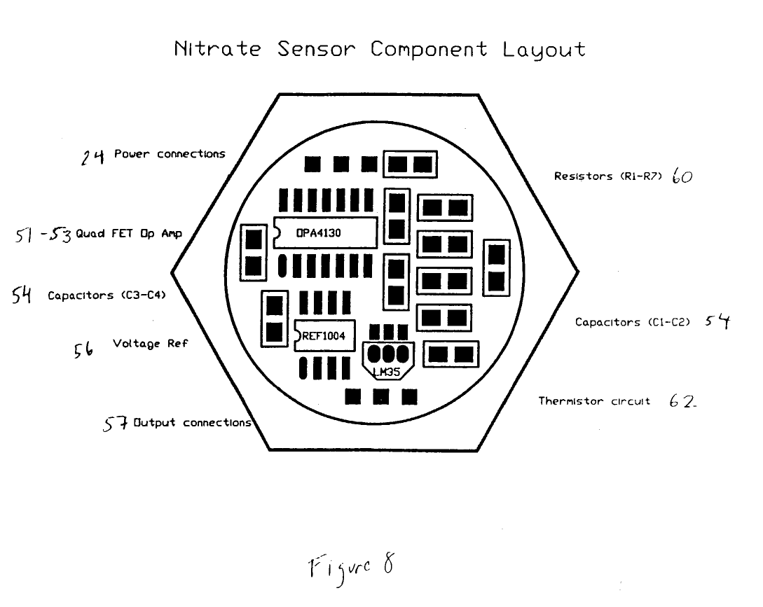

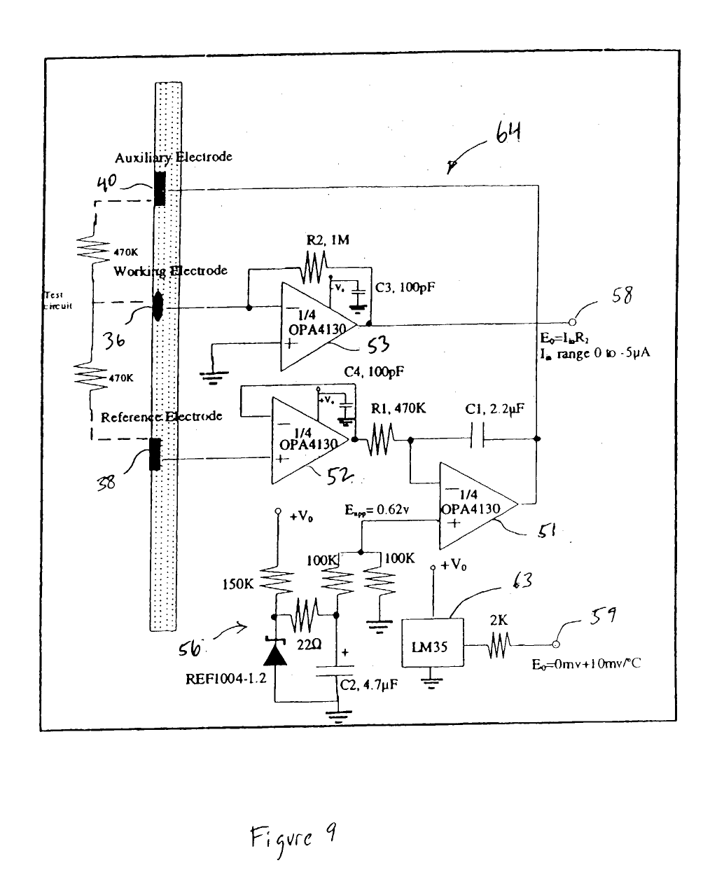

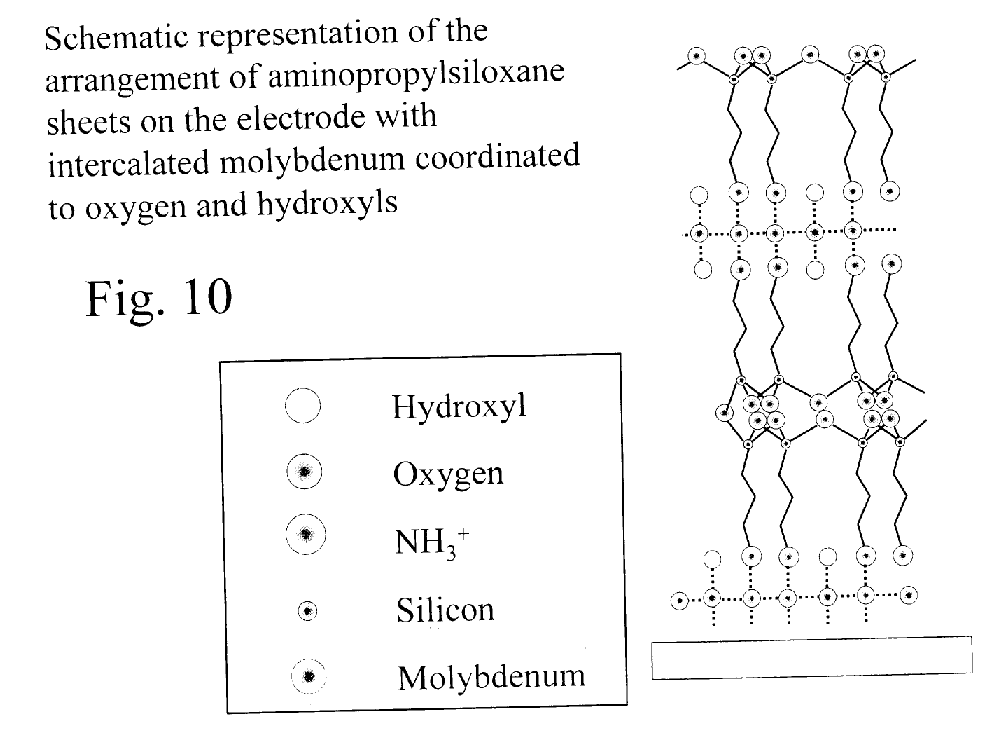

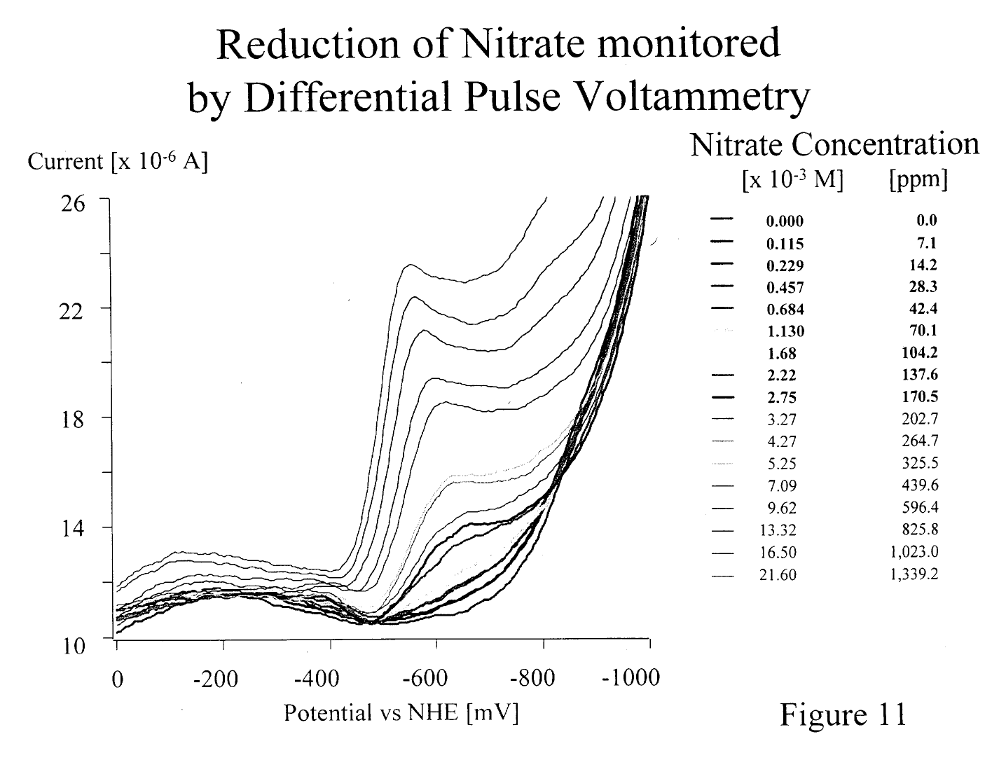

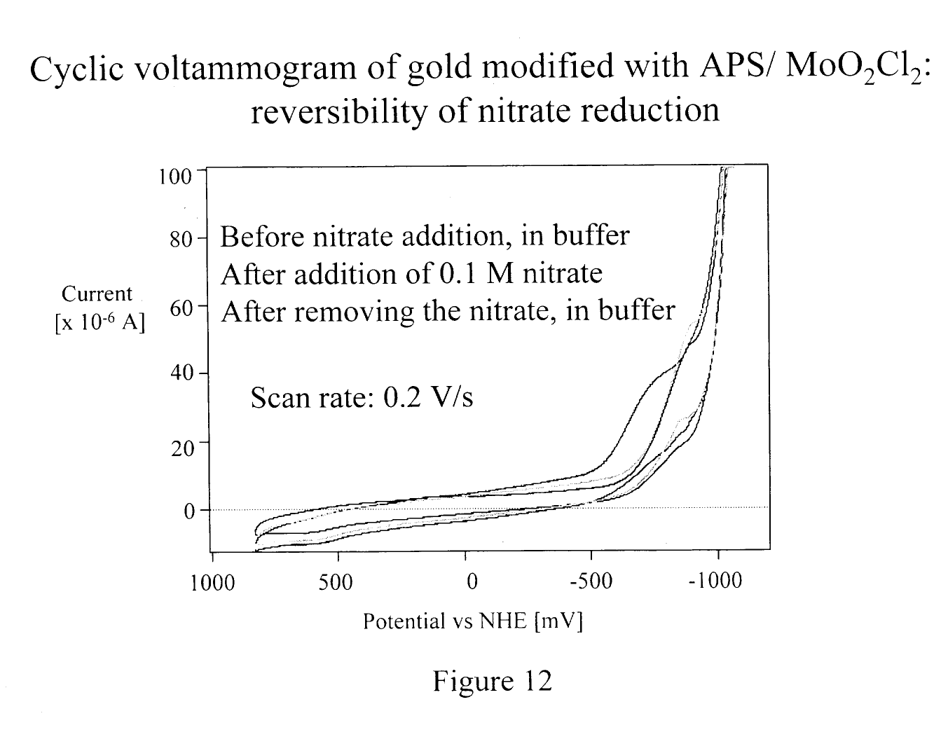

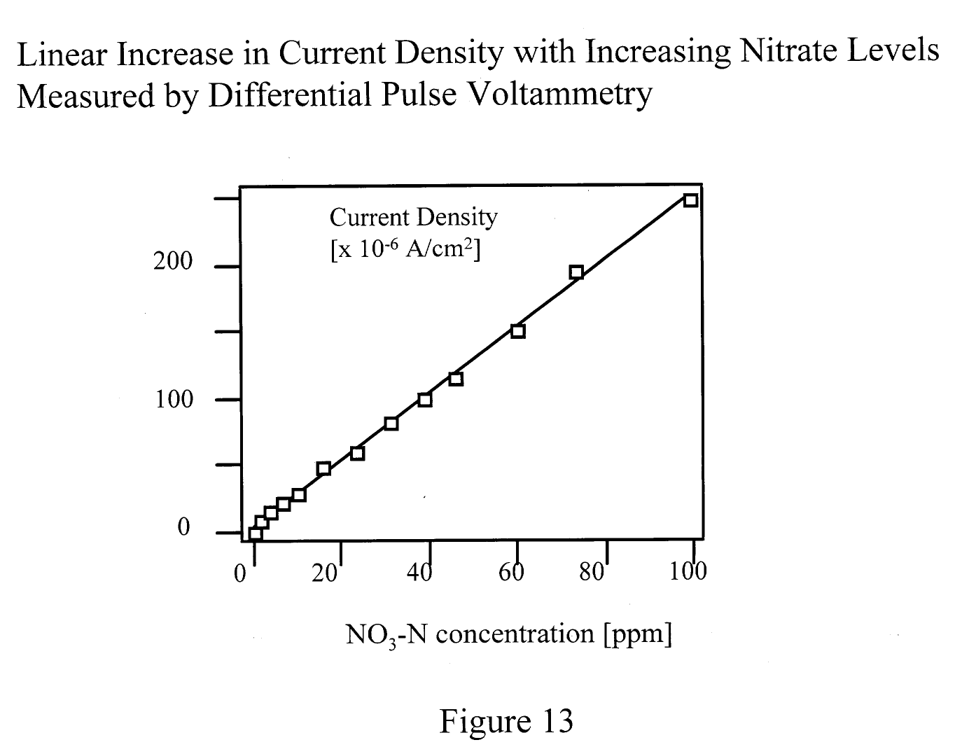

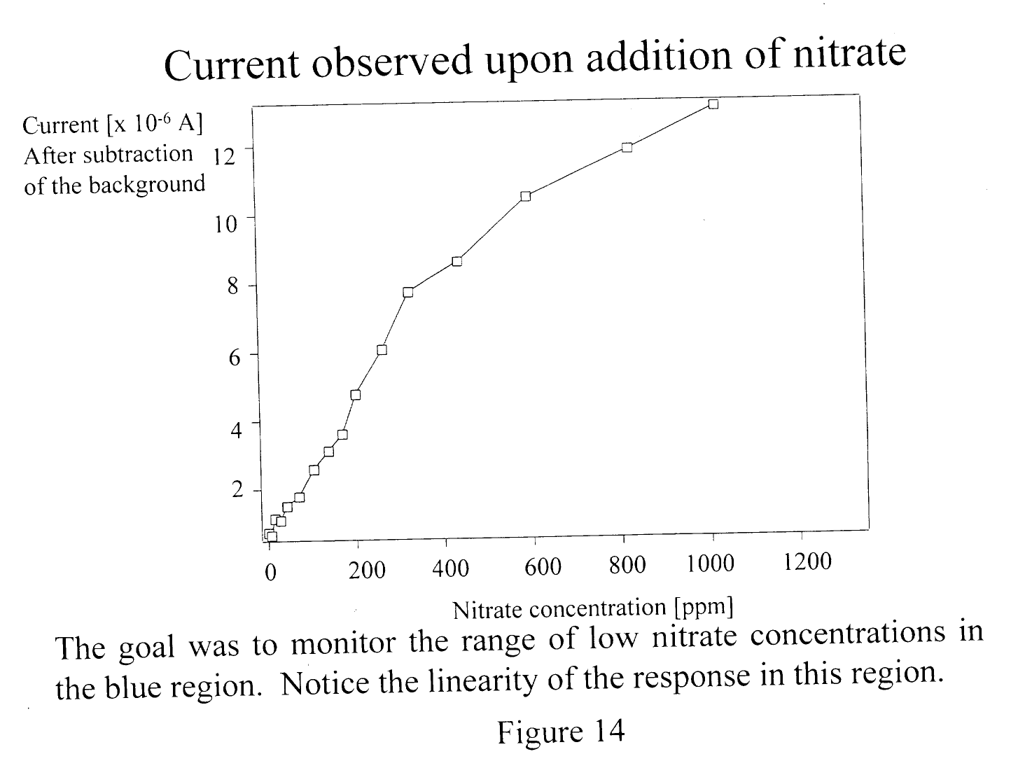

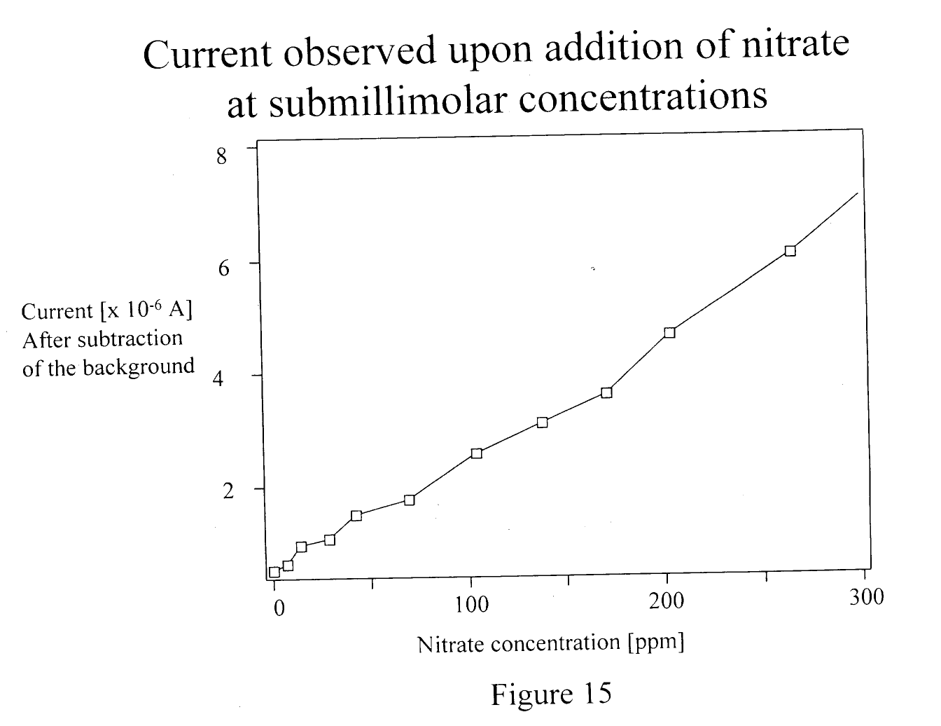

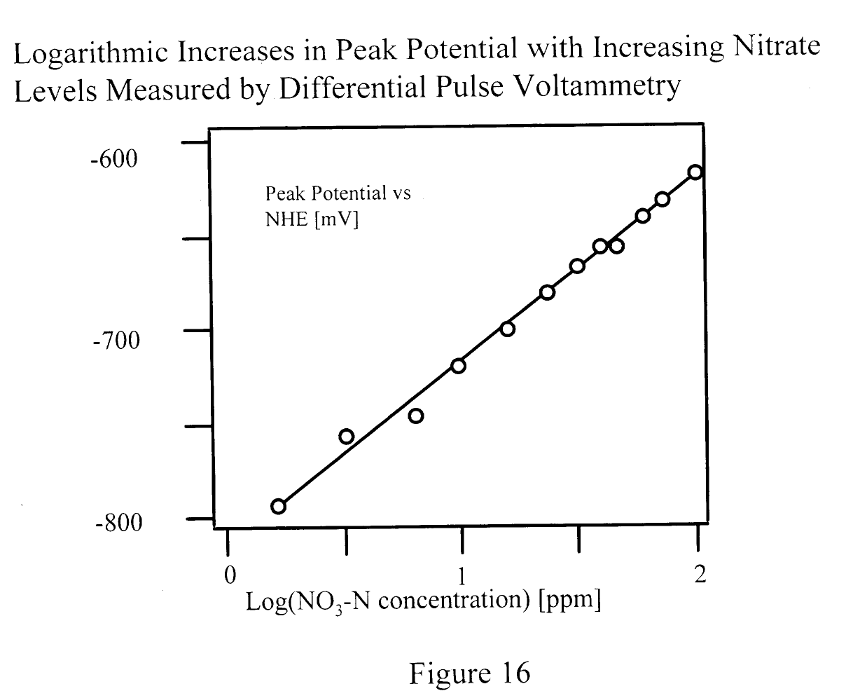

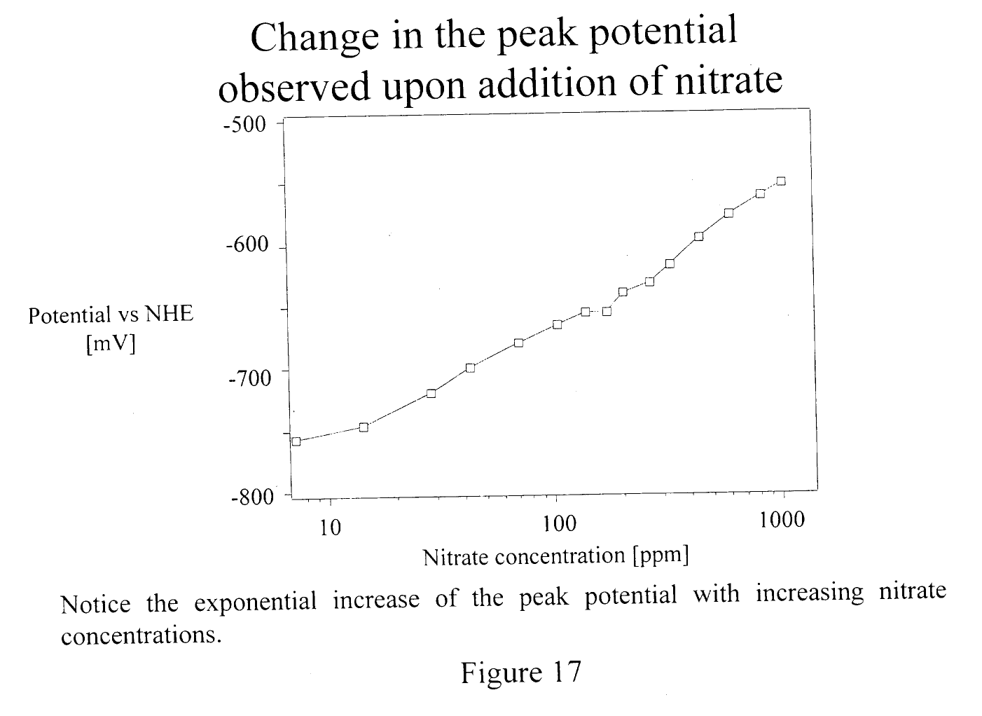

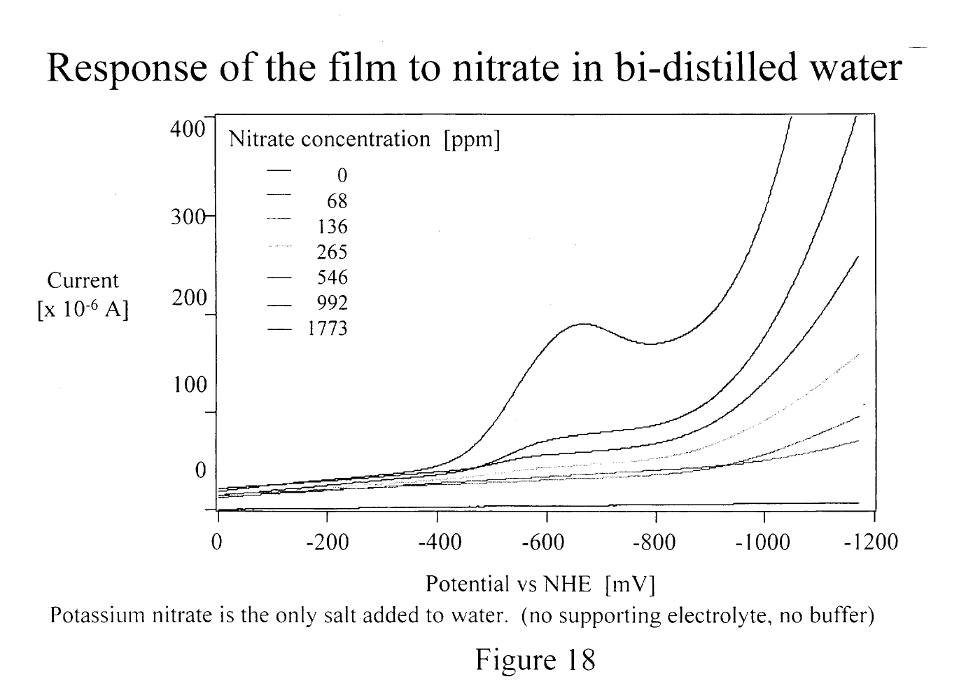

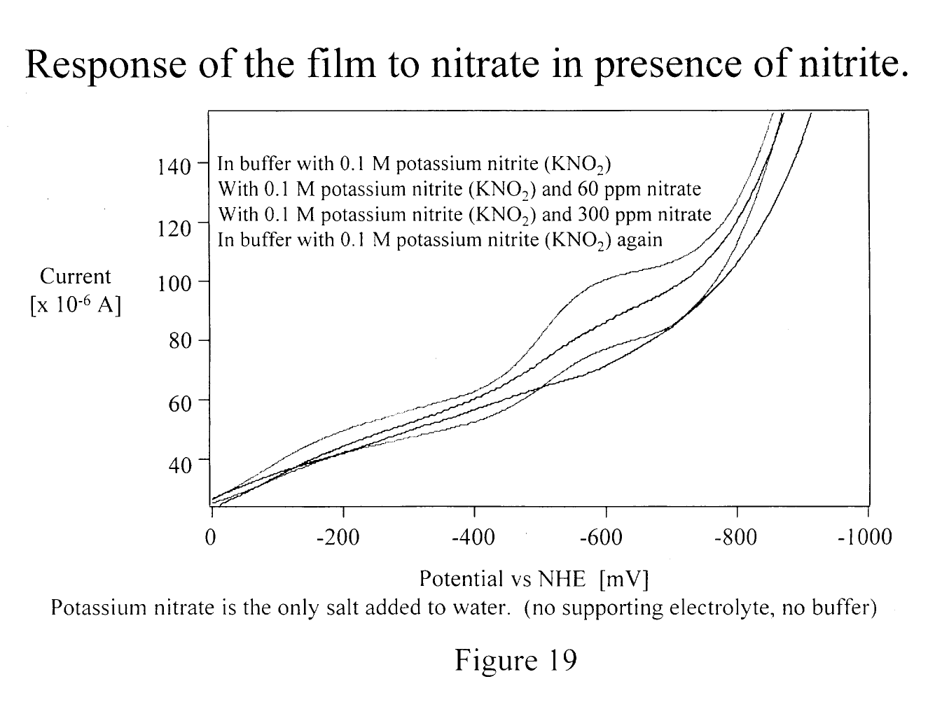

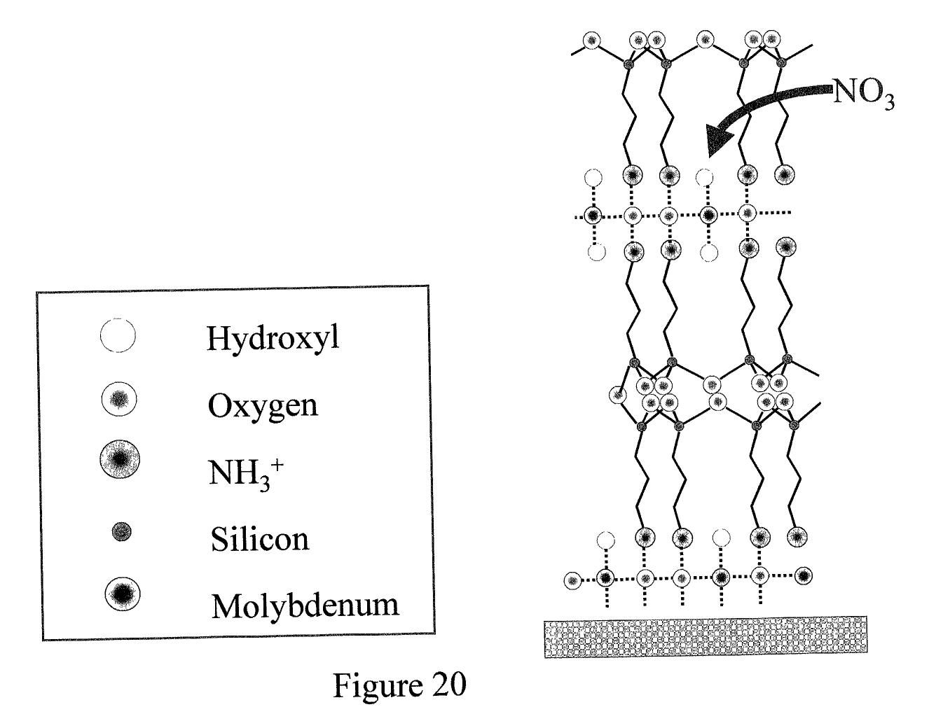

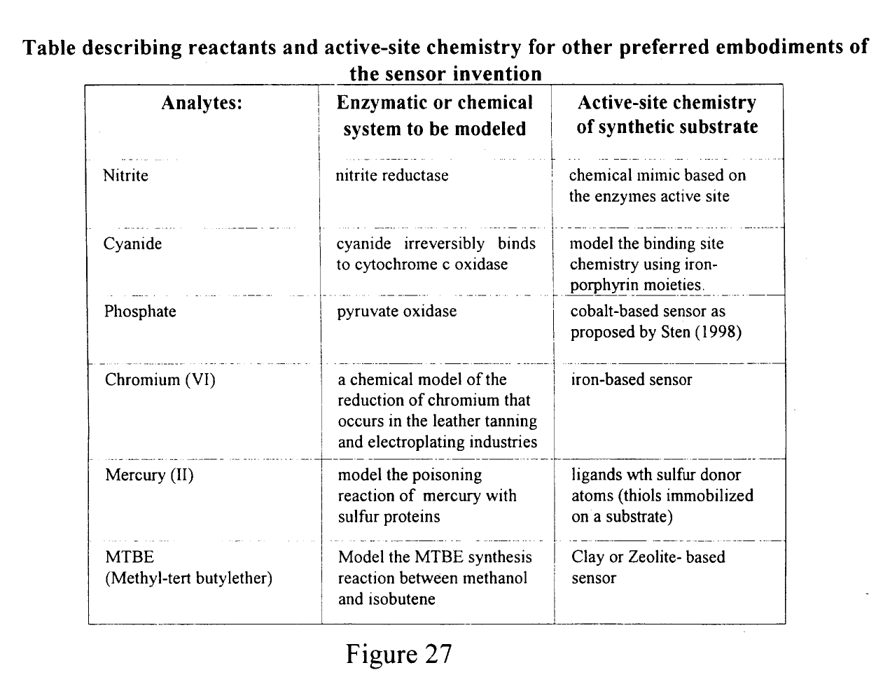

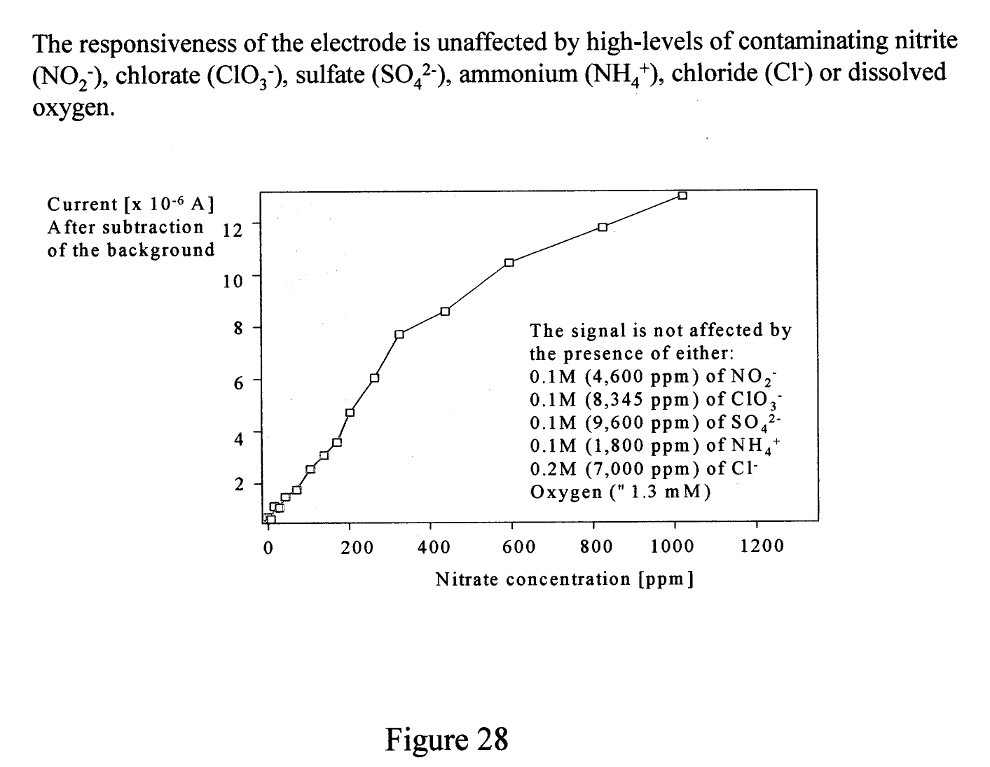

This implementation provides an embodiment of the present invention in which the sensor device is an apparatus which can be mounted in such a way that it can be removed and replaced. FIG. 2 shows a perspective view of this embodiment of the biosensor device as it is connected to a control box 50. The sensor cartridge 11 and the control box 50 are shown individually in FIGS. 2b and 2c, respectively. Preferably, the device is mounted in a housing or cartridge 11 of any required form so that the electrode surfaces in use for detecting nitrate in an aqueous solution are caused to be exposed to the aqueous solution. The cartridge 11 contains an encasement filler 46 which holds the chip or carrier 42 in place. The electrode system 34 is held in place on the surface of the chip 42 by the “vias or pad” mechanism described above. FIG. 6 shows a cross-sectional view of the sensor cartridge 11 detailing the chip 42, the electrode system 34, the o-ring seat 45, the collar 43 and the power supply and signal output 48. The top of the cartridge 11 is shown in FIG. 7 detailing the electrode side of the chip 42 is shown in FIG. 4., and an enlarged view of the bottom of the cartridge 11 showing the attachment screws 41. When the cartridge is inserted into a flow cell 12, the dot electrode 36 surface with the sensing element (e.g. synthetic substrate) is exposed to the mainstream flow 14 that allows for specific reaction between the test substance in solution and the sensing element disposed on the surface of the dot electrode 36. The cartridge 11 may also be exposed in a sample cell 12, suitable for single-sample measurements.

The specific reaction or coupling between the sensing element and the test substance of interest generates a signal (redox reaction causing electron flow between dot electrode 36 and redox center of sensing element), which comprises a response of the sensing element. Embodiments of the device, as described below, monitor the response of the sensing element.

The Faradic current at the electrode is detected and is proportional to the conversion to product by the sensing element. The signal 26 is compared against a set of calibrations based upon analytical standards as well as instrument features. The analog signal 26 can be read directly through a chart recorder 32, or digitized through microprocessor-controlled A/D acquisition. Either the analog 26 or digital signal 30 can be stored as needed. Included in the sensor temperature circuit 62 is a thermistor that monitors the temperature of the fluid 14 passing across the electrode 34 surfaces and reports temperature through the same circuitry. This allows for temperature correction of enzyme activity using standard Q₁₀ algorithms (Raison, J. K. and Berry, J. A. 1979, in Encyclopedia of Plant Physiology, New Series 12A:277-338).

Electrode Properties, Design and Manufacture

The electrodes 34 are located, as described above, on a carrier or chip 42 (preferably a multilayer ceramic substrate) as the dot (working) electrode 36, and the second (reference) and third (auxiliary) electrodes 38 and 40, respectively, concentrically arranged around the dot electrode 36 (see FIGS. 5 and 6).

During electrode production, the electrode patterns are silk-screened onto the top layer of the ceramic substrate of the chip 42, which may be a low-temperature, co-fired, ceramic substrate and preferably is made of DuPont 951 Green Tape (DuPont Electronic Materials, Research Triangle Park, N.C.) or any other suitable carrier. The electrode material may be selected from available metal inks. The device is built up in layers, much the same as used in ceramic-circuit-card technology. The electrodes and the electronics can reside on the same carrier substrate, the dot electrode 36 with the sensing elements on the top, and the circuit on the back. The vias and pads on the circuit side may be made of a platinum/silver alloy chosen for its solderability.

The preferred green tape ceramic material comes in a form very similar to sheets of paper. From the top layer down, the layers are built up to allow the electrode elements to connect directly to the circuit, and the remaining layers allow the current-carrying circuit tracks to be routed from point to point, in a manner well known to the art of ceramic card circuit building. See, Horowitz, J. Samuel and Needles, C. R. S., Smart Materials for Hybrid Circuits and Ceramic Multi-chip Modules, Proceedings 1995 Japan International Electronic Manufacturing Technology Symposium, Omiya, Japan, Dec. 4-6, 1995. The green ceramic layers are placed upon each other pressed and fired, fusing the ceramic and inks.

A preferred embodiment of the substrate has layers built up to give a final substrate thickness after firing of about 0.045 inches. These carrier substrates may be manufactured in sheets, with approximately 25 devices per sheet.

The surface-mount circuit components were applied to the ceramic card. The ceramic card or chip 42 is greatly variable in shape. Note that FIG. 4 shows a chip 42 in the shape of a square, whereas FIGS. 7 and 8 show the chip 42 in the shape of a hexagon. The hexagon shape provides space for additionally circuitry.

The surface-mount circuit components were applied to the chip 42 using standard surface-mount application techniques. FIG. 8 shows the layout of these circuit components when mounted on the back of the carrier 42. Further details of the circuitry are shown as an example of a preferred embodiment in FIG. 9. In FIG. 9, all the components are surface mount (SMD) type. The voltage is +V₀ between +5vdc and +18vdc, and −V₀ between −5vdc and −18vdc. The test circuit shown in the diagram produces −0.291vdc. All the resistors are 1%, 50 ppm temperature coefficient. The capacitors C1 and C2 are Tantalum chip +/−10% and capacitors C3 and C4 are Ceramic chip +/−5% and the integrated circuits (IC) shown are LM35, REF1004-1.2, OPA4130 or equivalent. Note, however, the E_{applied} would change depending on the analyte to be sensed since it determines the potential at which the biochemical reaction is occuring and maintains the sensing elements at the proper chemical valence.

This all-in-one module served as the backbone of the device. The device module was mounted into the geometry of choice for the application required. The device module was encapsulated into the cartridge 11 providing a watertight seal for the electronics with the electrodes 34 exposed to the fluid being measured.

The preferred sensor design yields the following benefits: 1) the device can be mass produced; 2) the circuitry can be collocated with the electrodes; 3) device material was stable in fresh and salt water as well as other liquids; and 4) the carrier 42 surface on which the electrodes are disposed can have virtually any geometry. This combination of features allows for a flexible design and a predictable performance.

The Device Controller

An embodiment of the invention includes a flow cell 12, which comprises a cartridge 11 at the end of which are dot 36, second 38, and auxiliary 40 concentric electrodes disposed on a carrier 42, in combination with a controller 50, as shown in FIG. 2 which contains a power supply 48 and can contain a microprocessor controller 50 and amplifier electronics 18, if they are not mounted on the back of the carrier 42, and the data logger. The controller 50 administers reference voltages 56 and electrode polarity through a common switching circuit in a manner that optimizes the portion of the electrical signal that is a direct indicator of the concentration of the nitrate being measured. In addition, the controller device 50 can contain an analog 26 or digital 30 interface for use with either analog or digital recording 32 and storage devices. Further, the controller device 50 can possess a display that could be either an LED, a meter, or other direct reporting device (e.g., a visual or audible alarm set at a preset level) that reveals the level of the electrical signal or a direct indicator of the concentration of nitrate measured. The controller 50 can operate on normal household current (e.g., 110 or 220 V) or on batteries for portable or expendable applications.

In one embodiment, the cartridge 11 containing the electrodes 34 may be connected electrically to a controller 50 as a source of power and as a means to report the signal from the sensing element on the working or dot electrode 36. The cartridge 11 may be designed to be replaceable and fully refurbishable in terms of both the sensing element and the electrode surface properties.

Cartridge Design and Function

The cartridge or protective housing 11 serves as a mechanical and protective structure for the device and device/electronics ceramic element. As such, the cartridge form can be variable, depending upon the intended use. For a general-purpose monitoring instrument, the cartridge is designed to be a cylindrical barrel that fits directly into a flow cell 12. As mentioned earlier, FIG. 6 shows a cross-sectional view of the sensor cartridge 11. The top of the cartridge 11 is shown in FIG. 7 and an enlarged view of the bottom of the cartridge 11 detailing the electrode side of the chip 42 is shown in FIG. 5. The cartridge is designed ultimately to be expendable/reusable, so that cost and size are the main considerations.

Flow Cell Design and Function

The device, in particular, the device embodied on a ceramic chip 42, was encapsulated into a cartridge barrel exposing the electrodes 34 to solution while protecting the circuitry. The signals from the electronics were fed directly via a connector to the topside electronics package 18. Each cartridge 11 had a cylindrical o-ring seal 47 to keep the flow cell 12 free from leaks.

The size and shape of the flow cell 12 are greatly variable due to the needs of each application. The whole purpose of the flow cell 12 is to allow the device to mate with the water supply 14 and to flow that supply past the dot electrode's sensing surface 37. A cell 12 was made from clear polycarbonate to allow the user to view the water flow 14. This was important, to ensure that no bubbles were trapped under the device. The cartridge 11 has barbed fittings at the input and output of the cell 12. This allows rapid connection to any diverted water flow 14 from the main source. This connection was designed for versatility and allowed for almost any type of fitting to be applied. This is shown in the block diagram in FIG. 1 and sensing system layout in FIG. 2. A cartridge 11 contains the sensing elements localized on a dot electrode 36, the auxiliary electrode 40, and the reference electrode 38 mounted on the chip 42 (see FIGS. 4 and 7), a thermistor and other electronics to control, collect and calibrate the data. The cartridge 11 is inserted in the flow stream 10 (see FIG. 2) and is replaceable. The side of the chip 42 opposite from the side bearing the electrodes contains the necessary electronics (see FIGS. 7 and 8) to control the system and provide the data stream in the format required.

The reporting modes for the devices will be varied, ranging from simple analog outputs 26 to chart recorders 32 and optical or acoustic alarms triggered at a preset threshold level, to RS232 ports for digital outputs 30 and telemetric outputs to remote sites.

The devices will come in several formats including stand-alone units for laboratory or plant use, battery-operated portable devices, or single-use devices. Submerged moored or towed devices are within the scope of the invention.

Modes of Use and Utility of the Invention

From the specific examples and the description herein of the invention, it is understood that the device can be modified for different sampling situations or regimes, and can accommodate a range of different sensing elements that can be reported directly or indirectly in an amperometric manner; and that the device of the invention can be implemented in a range of formats including stationary devices, portable devices and expendable or one-time-use devices. The device is suitable for detection and quantification of nitrate levels relevant to public health, industrial and commercial processes and to environmental protection.

The device is advantageously rugged, has long-term stability, and provides simple and flexible formats that allow for continuous flow-through assessments and for on-demand, single-sample or flow-through applications. The devices and methods of the invention are useful in a range of fields and applications. These include monitoring nitrate, or other biochemical agents, some of which are listed in FIG. 27, in municipal drinking water facilities; in wastewater treatment facilities; for environmental assessments of natural fresh, marine and estuarine waters; and for medical diagnostics. The devices of the invention find use for process-control needs in industrial, pharmaceutical, nutritional-supplements, beverage, and foodstuff manufacturing industries; food process streams; assessment and process control of industrial process streams; in fermentation processes; and in human and veterinary medical diagnosis. The applications of the methods of using the device to detect biochemical levels in solution all involve the steps of causing the sensing elements of the device to be exposed to an analyte, and monitoring the response of the sensing elements.

Device formats can range across table-top models operated using 110V, or hand-held portable formats that operate on batteries. In addition, the device can be designed in expendable or single-use formats. The single-use formats are embodied as self-contained and battery-operated, and have a simple LED or colorometric read-out, making them suitable for factory or home use.

Expendable formats or embodiments of the sensor that are desirable for environmental pollution monitoring, are self-contained and include a telemetric device, well known to those in the art, which can be coupled to a transreceiver (e.g. cellular phone) to report concentrations of test substances. Expendable formats find use for wide-area surveys of coastal and open-ocean waters, lakes and rivers where synoptic data is required on certain pollutants.

Nitrate Monitoring and Quantification.

In a preferred embodiment, the device and methods of the invention find use in the monitoring and assessment of nitrate levels in a range of waters, many or most of which are required by federal and state agencies to protect human health and the environment. These include drinking water (ground waters, surface waters, processed waters); wastewater streams (septic systems, municipal and industrial waste water treatment); source waters for production of food stuffs, including processed foods and beverages; and industrial process streams, such as saltwater boilers, metal ore processing and mining activities for example.

In addition, the device and methods of the invention find use in environmental monitoring of freshwater sources (such as lakes and rivers), marine and estuarine waters (such as bays, harbors), coastal and open-ocean waters where nitrate levels are ever-increasing sources of anthropogenic pollution.

Nitrate levels in drinking water and foods and beverages are regulated because of the risks they pose to human health, and particularly to pregnant women and infants. In infants, the consumption of water or foods with levels of nitrate equal to or exceeding 10 mg/L or 1 mg/L nitrite can result in “blue-baby syndrome.” This syndrome, which also can affect unborn fetuses, arises from an impaired oxygen-carrying capacity of hemoglobin in the blood due to the interaction of nitrite with hemoglobin. All consumed nitrate is rapidly reduced to nitrite by the bacterial flora of the stomach, making nitrite the toxic species. High nitrate levels in drinking water have also been linked to dramatically increased risks of certain cancers, particularly non-Hodgkin's lymphoma.

Summary of Device Embodiments or Formats

It is appreciated that the device of the invention finds a broad range of embodiments, each supporting a specific need in the field. Irrespective of the format, the basic sensor device of the invention is composed of two major components: 1) a housing with flow-through system and necessary electronics and power supplies, and 2) a replaceable cartridge 11 that will contain the device, which is composed of synthetic sensing elements disposed on the dot electrode 36. A data logger in the electronics section will use a standard IC chip. The data could be downloaded directly via an RS232 connector to a PC, or a transmitter can be supplied which will allow for remote polling of the device. Summaries of preferred embodiments of device formats and their applications are listed in FIGS. 29 and 30.

Further details concerning dimensions of preferred embodiment examples are listed in FIG. 31. FIG. 31, in particular, highlights the flexibility and extensive range of sizes in which the sensor device and its components can be produced. As pointed out earlier, a primary objective of this invention is manufacturing economy. For this reason we favor implementation of the invention in configurations that can be manufactured in the least-costly-possible way such as a light-weight, economical sensor device based on the minimum dimensions in FIG. 31

As the numbers in FIG. 31 demonstrate, a set of dimensions on the order of one inch by less than half an inch and on the order of 500 grams, or less is readily feasible for preferred embodiments of the invention. In a more highly preferred dimension the sensing element diameter is on the order of 0.375 inch by 0.064 inch thickness at a weight on the order of 50 grams, or less. This sensor format favors the single-use and hand-held portable applications of the device and based on these numbers can easily be mass produced and shipped at very low cost forseeably at about one dollar per sensor. While the larger formats are easy to implement and can be based on off-the-shelf ciruit components, whereas the small-sized sensor formats require circuit components that are part of an integrated chip, low-production cost of the small-sized sensor is a great advantage; especially in light of the costs and environmental hazards of the current nitrate detection technologies illustrated in FIG. 22.

Accordingly, the present invention is not limited to the specific embodiments illustrated herein. Those skilled in the art will recognize, or be able to ascertain that the embodiments identified herein and equivalents thereof require no more than routine experimentation, all of which are intended to be encompassed by claims.

What is claimed is:

1. A device for detecting an analyte in an aqueous solution, said device comprising:
(a) a carrier;
(b) a dot electrode disposed on said carrier; and
(c) one or more sensing elements disposed upon said dot electrode and reactive to said analytes.

2. The device of claim 1, wherein:
said carrier is a flat surface and said dot electrode comprises at least one noble metal or an alloy thereof.

3. The device of claim 2, wherein:
said noble metal is selected from the group consisting of gold, silver, platinum, palladium, iridium, rhenium, mercury, ruthenium and osmium.

4. The device of claim 1, wherein:
said dot electrode comprises a thin film.

5. The device of claim 1, wherein:
said dot electrode comprises a thick film.

6. The device of claim 1, wherein:
said dot electrode comprises a porous membrane.

7. The device of claim 6 wherein:
the porous membrane comprises a polymer.

8. The device of claim 1, wherein:
said carrier comprises a non-conducting material; and said non-conducting material is selected from the group consisting of glass, ceramic, and non-conducting polymers.

9. The device of claim 6, wherein:
the porous membrane comprises positive or negative electrostatic charges for providing increased selectivity towards the said analyte and providing ordering of the sensing element towards the dot electrode.

10. The device of claim 1, wherein:
said one or more sensing elements are selected from one or more of the group consisting of electron mediator-dependent sensing elements and electron mediator-independent sensing elements.

11. The device of claim 1, wherein:
said sensing elements are electron-mediator dependent and further comprising an electron mediator disposed on said dot electrode.

12. The device of claim 11, wherein:
said electron mediator is selected from the group consisting of azure A, bromphenol blue and endogenous electron mediators.

13. The device of claim 1, wherein:
said sensing element comprises an enzymatic substance.

14. The device of claim 13, wherein:
said enzymatic substance is an enzyme fragment (subunit) containing a Mopterin center.

15. The device of claim 13, wherein:
said enzymatic substance comprises one or more enzymes.

16. The device of claim 15, wherein:
said one or more enzymes is selected from one or more of the group of enzymes consisting of oxidases, oxidoreductases, hydrolases, and dehydrogenases, antibodies and nucleic acids.

17. The device of claim 15, wherein:
said one or more enzymes comprises nitrate reductase.

18. The device of claim 15, wherein:
said one or more enzymes comprises nitrite reductase.

19. The device of claim 15, wherein:
said one or more enzymes comprises glucose oxidase.

20. The device of claim 1, wherein:
a signal is generated upon the reaction of said sensing element and said analyte; and
comprises a gaining or losing of electrons from said dot electrode; wherein said gaining or losing of electrons comprises a current flowing in a circuit connected to the dot electrode upon the reaction of said sensing element and said analyte.

21. The device of claim 1, further comprising:
a housing in which said device is mounted for exposure of said electrodes and said sensing elements to said aqueous solution.

22. The device of claim 1, further comprising:
means for exposing said sensing element to said aqueous solution.

23. The device of claim 1 further comprising:
(a) a second electrode disposed on said carrier and concentrically arranged around said dot electrode; and
(b) a third electrode disposed on said carrier and concentrically arranged around said second electrode.

24. The device of claim 23, wherein:
the second and third electrodes comprise substantially the same metal as the dot electrode.

25. The device of claim 23, further comprising:
a first circuit electrically connecting the said second and third electrodes for producing a predetermined potential on one of the said second and third electrodes; and
a second circuit attached to said dot electrode whereby a current is produced in said circuit connected to said dot electrode when said sensing element reacts with said analyte in order to produce a signal proportionate to the concentration of said analyte in said solution.

26. The device of claim 25, wherein:
the second circuit comprises an operational amplifier to increase the quantity of the signal.

27. The device of claim 25, wherein:
the signal is a potential.

28. The device of claim 25, further comprising:
a circuit for measuring the temperature of said carrier for calibration of said signal received from said dot electrode.

29. The device of claim 25, further comprising:
means for receiving said signal and displaying the corresponding concentration of said analyte.

30. The device of claim 25, further comprising:
a chart recorder th at receives said signal and displays the corresponding concentration of said analyte.

31. The device of claim 25, further comprising:
an analog to digital converter that receives said signal and converts said signal to a digital signal.

32. The device of claim 31, further comprising:
a microprocessor for receiving and processing said digital signal.

33. The device of claim 32, wherein:
said microprocessor receives information concerning the temperature of the carrier and calibrates said digital signal using a calibration formula stored in memory.

34. The device of claim 31, further comprising:
means for receiving the digital signal and displaying the corresponding concentration of said analyte.

35. The device of claim 23, wherein:
(a) the carrier is a chip having a first surface;
(b) the dot electrode disposed on the first surface;
(d) the second electrode is a reference electrode con centrically arranged around said dot electrode and disposed upon said first surface; and
(e) the third electrode is an auxiliary electrode con centrically arranged around said reference elec trode and disposed upon said first surface.

36. The device of claim 35, wherein:
the chip has a second surface opposed to the first surface and further comprising:
at least one conductive via between the first and second surfaces for electrically connecting at least one electrode to the second surface; and
wherein the chip has a second surface opposed to the first surface to which the dot electrode, the auxiliary electrode and the reference electrode are each electrically connected to the second surface by a via; and
comprising at least one conductive pad disposed on the second surface and in electrical communication with at least one via.

37. A device for detecting an analyte in an aqueous solution; said device comprising:
(a) a carrier;
(b) a dot electrode disposed on said carrier;
(c) one or more sensing elements disposed upon said dot electrode and reactive to such analyte; wherein
said sensing elements comprise a synthetic unit modeled after an active-site chemistry of a reac tive molecule; and
(d) a signal transduction element.

38. The device of claim 37, wherein:
the reactive molecule is an enzyme, antibody or cellular receptor.

39. The device of claim 37, wherein:
the sensing elements undergo biological or chemical reaction to the analyte and in response thereto, develop an electrical signal at the dot electrode.

40. The device of claim 37, wherein:
the sensing elements undergo biological or chemical reaction to the analyte and in response thereto, develop an optical signal at the dot electrode.

41. The device of claim 40, wherein:
the transduction element comprises an optical sensor responsive to the reaction.

42. The device of claim 37, wherein:
the transduction element comprises electrical circuitry connected to the electrode.

43. The device of claim 42, wherein:
the transduction element converts a biological or chemical response into a measurable signal.

44. The device of claim 43, wherein:
the measurable signal is an optical signal, or an electrical signal received from the dot electrode.

45. The device of claim 44, wherein:
the optical signal is a fluorescence signal.

46. The device of claim 37, wherein:
the transduction element is immediately adjacent to the dot electrode.

47. The device of claim 37, wherein:
the transduction element is on the reverse of the dot electrode.

48. The device of claim 37, wherein:
said carrier is a flat surface and said dot electrode comprises at least one noble metal or an alloy thereof.

49. The device of claim 48, wherein:
said noble metal is selected from the group consisting of gold, silver, platinum, palladium, iridium, rhenium, mercury, ruthenium and osmium.

50. The device of claim 37, wherein:
said dot electrode comprises a porous membrane.

51. The device of claim 50, wherein:
the porous membrane comprises a polymer.

52. The device according to claim 50, wherein:
the porous membrane comprises positive or negative electrostatic charges for providing increased selectivity towards the analyte and providing ordering of said sensing elements toward the dot electrode.

53. The device of claim 37, wherein:
said sensing elements comprise a nitrate reductase fragment (subunit) containing a Mopterin center.

54. The device of claim 37, wherein:
the device is a unit weighing on the order of 500 grams, or less.

55. The device of claim 37, wherein:
the device is a unit having an outside diameter on the order of 5 inches, or less.

56. The device of claim 37, wherein:
the device is a unit having a thickness on the order of 0.5 inch, or less.

57. The device of claim 37, wherein:
the device is a unit weighing on the order of 50 grams, or less.

58. The device of claim 37, wherein:
the device is a unit having an outside diameter on the order of 0.375 inch, or less.

59. The device of claim 37, wherein:
the device is a unit having a thickness on the order of 0.064 inch, or less.

60. A method for making a device that comprises sensing elements reactive to one or more analytes in an aqueous solution, said method comprising the steps of:
coating a noble metal substrate with a synthetic polymer; wherein the synthetic polymer is modeled after an active-site chemistry of a molecule reactive to the analyte; and
disposing the substrate upon a carrier.

61. The method of claim 60, wherein:
the sensing elements comprise the synthetic-polymer coated substrate.

62. The method of claim 60, wherein coating the substrate further comprises the step of:
preparing a matrix medium in which the synthetic polymer is immobilized.

63. The method of claim 62, wherein the step of preparing the matrix medium comprises an organosilicon clay.

64. The method of claim 62, wherein the preparing step further comprises synthesizing an organosilicon clay; which comprises the steps of:
hydrolyzing a silane with methoxy groups to form a polysiloxane polymer; and
stirring continuously under aerobic conditions for a period of several hours or more.

65. The method of claim 64, wherein the hydrolyzing step comprises hydrolysis, in an alcohol, of:
an amino-containing methoxy-, dichloro-silane; or
an amino-containing silane having readily hydrolyzable groups such as chlorine-, methoxy or ethoxy-groups.

66. The method of claim 65, wherein the hydrolyzing step comprises hydrolyzing 3-aminopropyltrimethoxysilane.

67. A method for using a device for detecting one or more analytes in an aqueous solution, wherein said device comprises (1) a carrier, (2) a dot electrode disposed on said carrier, (3) one or more sensing elements disposed upon said dot electrode and reactive to said analytes, wherein said sensing elements comprise an active-site of a reactive biochemical molecule, and (4) a signal transduction element; said method comprising the steps of:
(a) causing said one or more sensing elements to be exposed to said aqueous solution; and
(b) monitoring response of said one or more sensing elements.

68. The method of claim 67, wherein:
the reactive site is a synthetic molecular unit that simulates natural occurrences of said active site.

69. The method of claim 67, wherein:
the steps of causing and monitoring involve environmental monitoring of an aqueous solution selected from the group consisting of natural fresh, marine, and estuarine waters.

70. The method of claim 67, wherein:
the steps of causing and monitoring involve medical diagnosis of body fluids and derivatives thereof.

71. The method of claim 67, wherein:
the steps of causing and monitoring involve analysis of aqueous solutions selected from the group consisting of municipal and rural drinking water sources.

72. The method of claim 67, wherein:
the steps of causing and monitoring involve analysis of aqueous solutions associated with wastewater treatment facilities.

73. The method of claim 67, wherein:
the steps of causing and monitoring involve assessment and process control of aqueous solutions associated with industrial process streams.

74. The method of claim 67, wherein:
the steps of causing and monitoring involve process-control and analysis of aqueous solutions in the manufacture of products selected from the group consisting of pharmaceuticals, nutritional supplements, foodstuffs, and beverages.
